(19) United States
(12) Patent Application Publication
(10) Pub. No.: US 2012/0174875 A1
(43) Pub. Date: Jul. 12, 2012

(54) ANIMAL GARMENT

(76) Inventor: Diane Wetzel, Foley, MO (US)

(21) Appl. No.: 13/393,288

(22) PCT Filed: Aug. 19, 2010
(86) PCT No.: PCT/US2010/046012

§ 371 Date: Feb. 29, 2012

Related U.S. Application Data
(60) Provisional application No. 61/238,175, filed on Aug. 30, 2009.

(51) Int. Cl. A01K 21/00; A01K 13/00

(52) U.S. Cl. 119/838; 119/850

(57) ABSTRACT

The present teachings describe garments that can help prevent an animal such as a dog from mating, spoiling or displaying other similar unwanted behaviors. The garments described herein generally provide coverings for the urogential region of an animal.

### PRIORITY STATEMENT

This application claims the benefit of and the priority to U.S. Provisional Application No. 61/238,175, filed on Aug. 30, 2009, which is incorporated herein by reference in its entirety.

### INTRODUCTION

Owners and keepers of animals such as dogs often need to deal with an unwanted behavior by an animal. For example, a mammal such as a non-neutered male dog can display mating behaviors, or can engage in spotting activity, and can cause damage, or unwanted matings.

### SUMMARY

The present inventor has realized a need for garments that can reversibly prevent an animal from engaging in such undesired activities. In view of this unmet need, the present inventor has developed garments adapted for covering the urogenital region of a quadruped animal, or for covering the penis of a male quadruped animal.

In various configurations, a garment of the present teachings can comprise an elastomeric material, which can be a material having a low coefficient of friction, such as spandex (polyurethane-polyurea copolymer, also known as “elastane”). A low-friction fabric used in a garment of the present teachings can be smooth and stretchy, such as spandex commonly used in swimwear and athletic garments. In some configurations, the garment can be made of Lycra® spandex (Invista™, subsidiary of Koch Industries, Inc., Wichita, Kans.). In some configurations, other fabrics having smoothness and elasticity properties similar to Lycra® spandex can also be used. In some configurations, a low-friction fabric can be a fabric described in U.S. Pat. No. 7,281,549 to Metzger, or Parafricta™ Fabric (APA Parafricta Ltd., Newport Pagnell, Buckinghamshire, UK).

In some configurations, a garment can include trim along one or more edges. Fabric comprising the trim can also be an elastomeric material such as spandex, and can be attached by any attachment means known to skilled artisans, such as stitching. In various configurations, the trim can be attached using a stretchable attachment, such as expandable stitching. Without limitation, expandable stitching that attaches the trim along a edge of the garment can allow for stretching of the trim, and can be, for example, transversely alternating stitching or stitching having a sinusoidal pattern. In some configurations, a garment can further comprise at least one absorbent pad. An absorbent pad can be situated adjacent to the urogenital cover, and can be adhered or attached to the urogenital cover, or can be positioned next to the animal urogenital region without any adhesive. Furthermore, an absorbent pad can be reversibly adhered or attached to the urogenital cover, and can be adapted or fitted to accommodate an animal's anatomy in the vicinity of the animal urogenital region. In various configurations, a garment of the present teachings can be adapted for different sizes and breeds of animal. For example and without limitation, as shown in FIG. 8, a garment of the present teachings can be adapted for a substantially elongate dog such as a daschshund.

In various embodiments of the present teachings, a garment can comprise at least one urogenital cover, at least one first attachment portion and at least one second attachment portion. In various configurations, a quadruped animal can be a mammal, and can be either male or female. A mammal of these configurations can be any quadruped mammal, such as, without limitation, a canine mammal, a feline mammal, an ovine mammal, a bovine mammal, a porcine mammal, a caprine mammal, an equine mammal, or a leporine mammal. In some preferred embodiments, the mammal can be a canine mammal, and can be of any known breed or size of dog.

In various configurations, two or more attachment portions of a garment can comprise at least one attachment. In various embodiments, an attachment comprised by a garment disclosed herein can be a reversible attachment. Any type of reversible attachment known to skilled artisans can be used. Non-limiting examples of such reversible attachments include velcro, buttons/buttonholes; hooks and eyes, snaps, and zippers.

In some embodiments, a garment can comprise a dorsolateral cover portion. The dorsolateral cover portion can comprise a dorsal cover adapted for covering the animal's dorsal region, a left lateral cover adapted for covering the animal's left lateral region and a right lateral cover adapted for covering the animal's right lateral region. A garment of these embodiments can further comprise a ventral cover portion extending between the left lateral cover and the right lateral cover, and also comprise a urogenital cover adapted for covering the animal's urogenital region. In various configurations, a garment of these embodiments can further comprise at least one posterior extension extending from the urogenital cover portion. Such an extension can extend from the urogenital cover, and can include a portion defining an aperture adapted to receive the animal tail therethrough. The extension can also include a portion adapted for covering the animal dorsal posterior region. This portion can extend between the portion defining an aperture adapted to receive the animal tail therethrough and the dorsolateral cover portion. In some configurations, the at least one posterior extension can further comprise the at least one first attachment portion, and the dorsolateral cover portion can comprise the at least one second attachment portion. In some configurations of these embodiments, a garment can comprise at least one attachment comprising the at least one first attachment portion and the at least one second attachment portion; furthermore, the at least one attachment can attach the posterior extension to the dorsal cover. In various aspects, the at least one attachment can be at least one reversible attachment, such as, without limitation, at least one velcro attachment, at least one button/buttonhole; at least one hook/eye, at least one snap, at least one zipper, or a combination thereof. In some preferred aspects, the at least one attachment can comprise velcro.

In some configurations, the at least one posterior extension of a garment of these embodiments can be a forked extension, comprising a first subsection comprising the urogenital cover and the portion defining the aperture adapted to receive the animal tail therethrough, and a plurality of additional subsections, each additional subsection extending from the portion defining the aperture to the dorsolateral cover. In these configurations, each additional subsection can comprise at least one attachment portion.

In some configurations, the at least one posterior extension of a garment of these embodiments can be a forked extension, comprising a first subsection comprising the urogenital cover and the portion defining the aperture, a left subsection extending from the portion defining the aperture to the left lateral cover, and a right subsection extending from the portion defining the aperture to the right lateral cover. A forked extension of these configurations can have, for example and without limitation, a “Y” shape or a “V” shape. In addition, in these configurations, the left subsection and the right subsection can each comprise at least one attachment portion.

In some configurations, a garment of these embodiments can further comprise a chest cover. A chest cover of these configurations can be adapted for covering the animal chest region. In addition, a garment of these embodiments can further define a head aperture for receiving the animal head therethrough. Furthermore, a garment of some of these configurations can further define a left anterior aperture adapted to receive an animal left anterior leg therethrough and a right anterior aperture adapted to receive an animal right anterior leg therethrough. In some alternative configurations, a garment can further define an aperture adapted to receive an animal right anterior and left anterior legs therethrough.

In some embodiments, a garment of the present teachings can comprise a cover adapted for covering the animal dorsal, left lateral, right lateral, ventral and urogenital regions. A cover of these embodiments can comprise a dorsal cover portion, a left lateral cover portion comprising at least one first attachment portion, and a right lateral cover portion comprising at least one second attachment portion. In addition, a garment of these embodiments can further comprise a left anterior extension comprising at least one left anterior attachment portion, a right anterior extension comprising at least one right anterior attachment portion, and a posterior extension defining an aperture for receiving the animal tail. Furthermore, in some configurations, a garment of these embodiments can further comprise 1) a urogenital cover portion adapted to cover the animal urogenital, left ventrolateral and right ventrolateral regions, 2) at least one left ventrolateral attachment portion, and 3) at least one right ventrolateral attachment portion. In some configurations, the left anterior extension and the right anterior extension can each extend obliquely from the dorsolateral cover. In addition, in some configurations, the at least one left anterior attachment portion and the at least one right anterior attachment portion can comprise at least one attachment adapted for attaching the anterior extensions to each other at the neck region of the animal. The garment can include at least one attachment comprising the at least one left ventrolateral attachment portion of the posterior extension and the at least one first attachment portion, and at least one attachment comprising the at least one right ventrolateral attachment portion of the posterior extension and the at least one second attachment portion. In various configurations each attachment can be a reversible attachment, and can be independently selected, such as and without limitation, at least one velcro attachment, at least one button/buttonhole; at least one hook/eye, at least one snap, at least one zipper, or a combination thereof. In some preferred configurations, an attachment can be a velcro attachment.

In some embodiments, a garment of the present teachings can comprise a ventral cover adapted for covering the animal's abdomen and chest regions; a left dorsolateral cover comprising at least one first attachment portion; a right dorsolateral cover comprising at least one second attachment portion; a left anterior extension comprising at least one left anterior attachment portion; a right anterior extension comprising at least one right anterior attachment portion; and a posterior extension defining an aperture for receiving the animal tail. In various configurations, the posterior extension can comprise 1) a urogenital cover portion adapted to cover the animal urogenital region, 2) a dorsoposterior portion adapted to cover the animal dorsal posterior region. In some embodiments, a garment can comprise a posterior extension comprising a first subsection comprising the urogenital cover and the portion defining the aperture adapted to receive the animal tail therethrough, and a plurality of additional subsections, each additional subsection extending from the portion defining the aperture to the dorsolateral cover. In various configurations, each additional subsection can comprise at least one attachment portion. In various configurations, a posterior extension can comprise a first subsection comprising the urogenital cover and the portion defining the aperture, a left subsection extending from the portion defining the aperture to the left lateral cover, and a right subsection extending from the portion defining the aperture to the right lateral cover. In these configurations, the left subsection and the right subsection can each comprise at least one attachment portion.

In various configurations, a dorsoposterior portion can comprise at least one left dorsoposterior attachment portion and at least one right dorsoposterior attachment portion. In these embodiments, each anterior extension can extend obliquely from the abdominal cover. In some configurations, a garment of these embodiments can comprise a) at least one left dorsal attachment comprising the at least one first attachment portion and the at least one left attachment portion of the posterior extension; b) at least one right dorsal attachment comprising the at least one second attachment portion and the at least one right attachment portion of the posterior extension; and c) at least one anterior attachment comprising the at least one left anterior attachment portion and the at least one right anterior attachment portion. In some configurations, a garment can comprise a posterior extension comprises a first subsection comprising the urogenital cover and the portion defining the aperture adapted to receive the animal tail therethrough, and a plurality of additional subsections, each additional subsection extending from the portion defining the aperture to the dorsolateral cover, and wherein each additional subsection comprises at least one attachment portion. In some configurations, each attachment can be a reversible attachment, and can be independently selected from at least one velcro attachment, at least one button/buttonhole; at least one hook/eye, at least one snap, at least one zipper, and a combination thereof. In some preferred embodiments, each reversible attachment can be a velcro attachment.

In some embodiments, a garment of the present teachings can comprise a ventral cover; a left dorsolateral cover comprising the at least one first attachment portion (i.e., a left dorsal attachment portion), wherein the at least one first attachment portion is adapted to the animal dorsal midline; a right dorsolateral cover comprising the at least one second attachment portion (i.e., a right dorsal attachment portion), wherein the at least one second attachment portion is adapted to the animal dorsal midline; and a posterior extension defining an aperture for receiving the animal tail. The posterior extension can comprise 1) a urogenital cover portion adapted to cover the animal urogenital region, and 2) a dorsoposterior portion adapted to cover the animal dorsal posterior region. In various configurations, the dorsoposterior portion can comprise at least one dorsoposterior attachment portion, an anterior left extension; and an anterior right extension. In some configurations, the anterior left extension and the anterior right extension can be contiguous, or can be attached irreversibly (e.g., can be sewn together), or can be attached reversibly. In these configurations, a garment can define an aperture for receiving the animal front legs therethrough.

In some embodiments, a garment of the present teachings can comprise a ventral cover; a left dorsolateral cover comprising the at least one first attachment portion and at least one left secondary attachment portion; a right dorsolateral cover comprising the at least one second attachment portion and at least one right secondary attachment portion; an anterior left extension; an anterior right extension; and a posterior extension comprising 1) a urogenital cover portion, 2) a dorsoposterior portion comprising at least one left dorsoposterior attachment portion and at least one right dorsoposterior attachment portion. In some configurations, the anterior left extension and the anterior right extension can be attached, whereby the garment defines an aperture for receiving the animal front legs therethrough. In addition, in some configurations, a garment can comprise at least one primary attachment adapted to the animal dorsal midline. A primary attachment can comprise at least one first attachment portion and at least one second attachment portion. A garment of these embodiments can also comprise at least one left secondary attachment comprising the at least one left secondary attachment portion and the at least one left dorsoposterior attachment portion, and at least one right secondary attachment comprising the at least one right secondary attachment portion and the at least one right dorsoposterior attachment portion. As with other embodiments, an attachment of these embodiments can be any kind of attachment for garments known to skilled artisans, such as, without limitation, a reversible attachment, such as, without limitation, a velcro attachment, a button/buttonhole; a hook/eye, a snap, or a zipper. In preferred embodiments, an attachment can be a velcro attachment.

In some embodiments, a garment of the present teachings can comprise a ventral cover; a left dorsolateral cover comprising the at least one first attachment portion and at least one left secondary attachment portion; a right dorsolateral cover comprising the at least one second attachment portion and at least one right secondary attachment portion; an anterior left extension; an anterior right extension; and a posterior extension comprising 1) a urogenital cover portion, 2) a dorsoposterior portion comprising at least one left dorsoposterior attachment portion and at least one right dorsoposterior attachment portion. In some configurations, the anterior left extension and the anterior right extension can be attached, whereby the garment defines an aperture for receiving the animal front legs therethrough. In addition, in some configurations, a garment can comprise at least one primary attachment adapted to the animal dorsal midline. A primary attachment can comprise at least one first attachment portion and at least one second attachment portion. A garment of these embodiments can also comprise at least one left secondary attachment comprising the at least one left secondary attachment portion and the at least one left dorsoposterior attachment portion, and at least one right secondary attachment comprising the at least one right secondary attachment portion and the at least one right dorsoposterior attachment portion. As with other embodiments, an attachment of these embodiments can be any kind of attachment for garments known to skilled artisans, such as, without limitation, a reversible attachment, such as, without limitation, a velcro attachment, a button/buttonhole; a hook/eye, a snap, or a zipper. In preferred embodiments, an attachment can be a velcro attachment.

In some embodiments, a garment of the present teachings can comprise a ventral cover; a left dorsolateral cover comprising the at least one first attachment portion; a right dorsolateral cover comprising the at least one second attachment portion; wherein the left dorsolateral cover is adjoined to the right dorsolateral cover; an anterior left extension; an anterior right extension; and a posterior extension comprising 1) a urogenital cover portion, 2) a portion defining an aperture adapted to receive the animal tail therethrough, and 3) a dorsoposterior portion comprising at least one left dorsoposterior attachment portion and at least one right dorsoposterior attachment portion. A garment of these embodiments can be adapted to encircle an animal's trunk. In some configurations, the anterior left extension and the anterior right extension can be adjoined, whereby the garment can define an aperture for receiving the animal front legs therethrough and an aperture for receiving the animal head therethrough. In some configurations, a garment of these embodiments can further comprise at least one first attachment comprising a) the at least one first attachment portion, and b) the at least one left dorsoposterior attachment portion; and at least one second attachment comprising a) the at least one second attachment portion, and b) the at least one right dorsoposterior attachment portion. In various configurations, an attachment comprised by a garment of these embodiments can be a reversible attachment, such as, without limitation, a velcro attachment, a button/buttonhole; a hook/eye, a snap, or a zipper.

In some embodiments, a garment of the present teachings can comprise a ventral cover; a left dorsolateral cover comprising the at least one first attachment portion, wherein the at least one first attachment portion is adapted to the animal dorsal midline; a right dorsolateral cover comprising the at least one second attachment portion, wherein the at least one second attachment portion is adapted to the animal dorsal midline: an anterior left extension; an anterior right extension; and a posterior extension comprising 1) a urogenital cover portion, 2) a dorsoposterior portion comprising at least one left dorsoposterior attachment portion and at least one right dorsoposterior attachment portion. In some configurations, the anterior left extension and the anterior right extension can be attached. The garment can thereby define an aperture for receiving the animal front legs therethrough.

In some configurations of these embodiments, a garment can include at least one attachment of the dorsolateral covers and the dorsoposterior portion. in some configurations, at least one of the at least one first attachment portion and the at least one second attachment portion can further comprise at least one second dorsoposterior attachment portion. Accordingly, a garment of these configurations can comprise at least one first attachment comprising a) the at least one first attachment portion, and b) at least one second attachment portion. Furthermore, in these configurations, a garment can also comprise c) the at least one first dorsoposterior attachment portion and d) the at least one second dorsoposterior attachment portion. Attachments of garments of these configurations can be reversible attachments, such as, without limitation, at least one velcro attachment, at least one button/buttonhole; at least one hook/eye, at least one snap, at least one zipper, or combinations thereof. In some preferred configurations, an attachment can be a velcro attachment.

Some aspects of the present teachings include a garment adapted for covering the penis of a male quadruped animal. In various embodiments, a garment of these aspects can comprise at least one portion adapted to cover the penis of a male quadruped mammal; at least one first attachment portion; and at least one second attachment portion. In some embodiments, a garment of these aspects can comprise a primary portion adapted to a) encircle at least a portion of a male mammal's trunk and b) cover the male mammal's penis. In these embodiments, a primary portion can comprise a first flap and a second flap. The first flap can comprise at least one first attachment portion and the second flap can comprise at least one second attachment portion. A male quadruped mammal can be any male quadruped mammal, such as a canine male mammal, a feline male mammal, an ovine male mammal, a bovine male mammal, a porcine male mammal, a caprine male mammal, an male equine mammal, or a leporine male mammal. In preferred embodiments, the mammal can be a male canine.

In various embodiments, a garment of these aspects can comprise a dorsal cover comprising the at least one first attachment portion along a lateral edge of the dorsal cover; a ventrolateral cover extending from the dorsal cover, comprising the at least one second attachment portion, said ventrolateral cover adapted to cover the male mammal left lateral, dorsal, right lateral and ventral regions and a male mammal penis; a first extension extending from the dorsolateral cover, comprising at least one third attachment portion; and a second extension extending from the dorsolateral cover, comprising at least one fourth attachment portion. In some configurations, the first extension can be longer than the second extension.

In some embodiments, a garment of these aspects can further comprise at least one absorbent pad. The at least one absorbent pad can be adjacent to the portion adapted to cover the penis. In some configurations, the at least one absorbent pad can be adhered to the portion adapted to cover the penis. In some configurations, the at least one absorbent pad can be reversibly adhered to the portion adapted to cover the penis. In addition, in some configurations, the at least one absorbent pad can be adapted to be positioned adjacent to the animal's penis.

In various configurations of these embodiments, a garment can further comprise at least one first attachment comprising the at least one first attachment portion and the at least one second attachment portion; and a second attachment comprising the at least one third attachment portion and the at least one fourth attachment portion. The first extension, the second extension and the dorsal cover can together define an aperture adapted to receive the male mammal's neck. As with other embodiments, each attachment can be a reversible attachment, such as, without limitation, a velcro attachment, a button/buttonhole; a hook/eye, a snap, or a zipper. In preferred configurations, a reversible attachment can be a velcro attachment.

In various embodiments, a garment of these aspects can comprise a ventral cover adapted to cover the animal's abdomen and penis; a left lateral cover adapted to extend to the animal's dorsum, the left lateral cover comprising the at least one first attachment portion; a right lateral cover adapted to extend to the animal's dorsum, the right lateral cover comprising the at least one second attachment portion; an anterior extension extending from the ventral cover, adapted to cover the animal chest region. The anterior extension can further compromise a) a left strap comprising at least one third attachment portion, and b) a right strap comprising at least one fourth attachment portion.

In various configurations of these embodiments, a garment can further comprise at least one first attachment comprising the at least one first attachment portion and the at least one second attachment portion, the attachment adapted to be situated along the animal dorsum; and a second attachment comprising the at least one third attachment portion and the at least one fourth attachment portion. In these configurations, the anterior extension including the left strap and the right strap can define an aperture adapted to receive the animal neck. As with other embodiments, each attachment can be a reversible attachment, such as, without limitation, a velcro attachment, a button/buttonhole; a hook/eye, a snap, or a zipper. In preferred configurations, a reversible attachment can be a velcro attachment.

In various embodiments, a garment of these aspects can comprise a ventral cover adapted to cover the male quadruped mammal's abdomen and penis; a left lateral cover extending from the ventral cover, the left lateral cover adapted to extend to the animal's dorsum, and further comprising the at least one first attachment portion; a right lateral cover extending from the ventral cover, the right lateral cover adapted to extend to the animal's dorsum, and further comprising the at least one second attachment portion: an extension extending from the ventral cover, adapted to extend anteriorly over the animal ventral region, said extension further comprising at least one third attachment portion and at least one fourth attachment portion.

In various configurations of these embodiments, a garment can further comprise a) at least one dorsal attachment comprising the at least one first attachment portion and the at least one second attachment portion, and b) at least one anterior attachment comprising the at least one third attachment portion, and the at least one fourth attachment portion, whereby the at least one anterior attachment and the extension form a loop adapted to secure the extension to an animal neck collar. As with other embodiments, each attachment can be a reversible attachment, such as, without limitation, a velcro attachment, a button/buttonhole; a hook/eye, a snap, or a zipper. In preferred configurations, a reversible attachment can be a velcro attachment.

In various aspects, the present teachings include a garment for covering the penis of a male quadruped mammal. A garment of these aspects can comprise a primary portion adapted to encircle at least a portion of a male mammal's trunk, and is also adapted to cover the male mammal's penis. A primary portion of these aspects can comprise a first flap and a second flap, wherein the first flap comprises at least one first attachment portion and the second flap comprises at least one second attachment portion. In some configurations, a garment of these aspects can further comprise at least one absorbent pad. An absorbent pad can be situated adjacent to the penis cover, and can be adhered or attached to the penis cover, or can be positioned next to the animal penis without any adhesive.

In some embodiments, the flaps can be of unequal area or of unequal length, i.e., on flap can be longer than the other. In these embodiments, at least one first attachment portion can be along a lateral edge of the first flap, and the at least one second attachment portion can be along a lateral edge of the second flap. In further configurations of these embodiments, the garment can further comprise a first extension extending from the primary portion, the first extension comprising at least one third attachment portion. The garment can additionally comprise a second extension extending from the primary portion, the second extension comprising at least one fourth attachment portion. In some configurations, the first extension and the second extension can be of unequal lengths. In these configurations, the at least one first attachment portion and the at least one second attachment portion can comprise an attachment adapted to be situated along the animal trunk on a lateral side, which can be the right or left side. Furthermore, the extensions and an attachment comprising the third and forth attachment portions can define an aperture for receiving the animal head therethrough, and can, with the remainder of the garment, define an aperture for receiving the animal forelegs therethrough. As with other embodiments, each attachment can be a reversible attachment, such as, without limitation, a velcro attachment, a button/buttonhole; a hook/eye, a snap, or a zipper. In preferred configurations, a reversible attachment can be a velcro attachment.

In some embodiments, a garment for covering the penis of a male quadruped mammal of the present teachings can further comprise a chest cover extending from the primary portion; a first extension extending obliquely from the chest cover, the first extension comprising at least one third attachment portion; and a second extension extending obliquely from the chest cover, the second extension comprising at least one fourth attachment portion, wherein the first extension and the second extension are of equal lengths.

In some configurations, a garment of these embodiments can comprise at least one first attachment comprising the at least one first attachment portion and the at least one second attachment portion; and a second attachment comprising the at least one third attachment portion and the at least one fourth attachment portion, wherein the first attachment is adapted to be worn along the animal dorsum, and whereby the first extension and the second extension define a first aperture adapted to receive the male mammal's head and neck, and whereby the garment defines an aperture adapted to receive the male mammal's forelegs. As with other embodiments of the present teachings, each attachment can be a reversible attachment, such as, without limitation, a velcro attachment, a button/buttonhole; a hook/eye, a snap, or a zipper. In preferred configurations, a reversible attachment can be a velcro attachment.

In various aspects, the present teachings include a garment for covering the penis of a male quadruped mammal. A garment of these aspects can comprise a primary portion adapted to encircle at least a portion of a male mammal's trunk, and is also adapted to cover the male mammal's penis. A primary portion of these aspects can comprise a first flap and a second flap, wherein the first flap comprises at least one first attachment portion and the second flap comprises at least one second attachment portion. In some configurations, a garment of these aspects can further comprise at least one absorbent pad. An absorbent pad can be situated adjacent to the penis cover, and can be adhered or attached to the penis cover, or can be positioned next to the animal penis without any adhesive. In some embodiments, a primary portion of a garment of these aspects can comprise two symmetrically disposed flaps, wherein a first flap comprises the at least one first attachment portion and a second flap comprises the at least one second attachment portion. In various configurations, a garment can further comprise an extension extending from the primary portion. The extension can be adapted to extend anteriorly over the animal ventral region. In various configurations, the extension can further comprise at least one third attachment portion and at least one fourth attachment portion. In some configurations, a garment of these embodiments can comprise at least one dorsal attachment comprising the at least one first attachment portion and the at least one second attachment portion, and at least one anterior attachment comprising the at least one third attachment portion and the at least one fourth attachment portion. In some configurations, an anterior attachment and an anterior extension can form a loop, which can be adapted to secure the extension to an animal neck collar. As with other embodiments of the present teachings, each attachment can be a reversible attachment, such as, without limitation, a velcro attachment, a button/buttonhole; a hook/eye, a snap, or a zipper. In preferred configurations, a reversible attachment can be a velcro attachment.

### BRIEF DESCRIPTION OF THE DRAWINGS

FIG. 1 A-F illustrates various views of one embodiment of the garment of the present disclosure.

FIG. 2 A-H illustrates various views of one embodiment of the garment of the present disclosure.

FIG. 3 A-E illustrates various views of one embodiment of the garment of the present disclosure.

FIG. 4 A-E illustrates various views of one embodiment of the garment of the present disclosure.

FIG. 5 A-E illustrates various views of one embodiment of the garment of the present disclosure.

FIG. 6 A-E illustrates various views of one embodiment of the garment of the present disclosure.

FIG. 7 A-E illustrates various views of one embodiment of the garment of the present disclosure.

FIG. 8 A-E illustrates various views of one embodiment of the garment of the present disclosure.

FIG. 9 A-E illustrates various views of one embodiment of the garment of the present disclosure.

FIG. 10 A-F illustrates various views of one embodiment of the garment of the present disclosure.

FIG. 11 A-G illustrates various views of one embodiment of the garment of the present disclosure.

FIG. 12 A-E illustrates various views of one embodiment of the garment of the present disclosure.

FIG. 13 A-E illustrates various views of one embodiment of the garment of the present disclosure.

FIG. 14 A-E illustrates various views of one embodiment of the garment of the present disclosure.

### DETAILED DESCRIPTION

The present teachings disclose garments for preventing undesirable animal behaviors, such as mating or spotting by dogs. The garments described herein are composed of fabric, preferably a fabric that is smooth and stretchy, such as Lycra® spandex. In addition to spandex, other fabrics that have a low coefficient of friction can also be used, such as, for example, polyester, nylon or polypropylene. Any low friction fabric can be used that has a low coefficient of friction, such as Lycra® spandex. Material comprising a garment of the present teaching can be smooth and stretchy. A garment can be sufficiently tight-fitting on an animal such as a dog, and can comprise a fabric that is sufficiently smooth, such that the animal is unable to rub the garment off, for example by rubbing against furniture. Smoothness of a fabric can be determined by methods well known to skilled artisans, such as described in Gupta, B. ed. Friction in Textile Materials (Wooodhead Publishing in Textiles), CRC Press, 2008. Garments of the present teachings can be made by standard methods well known to skilled artisans, including cutting and sewing of fabrics. A garment comprising attachment portions can be placed on animal such as a dog; the attachment portions can be combined to form attachments, such as velcro attachments. These attachments can secure the garment to the animal.

“Panel” as used herein refers to a shaped piece of fabric. A depiction of a panel set forth in a figure can be used as pattern. Furthermore, a depiction of a panel can be scaled to larger or smaller sizes for constructing garments of different sizes. In some embodiments, panels can be attached by seams comprising stitching. The stitching on the seam can be straight stitching, a box stitch, a zig zag stitch, a tricot stitch, a rampart stitch, a ric rac stitch, a stretch hem stitch, or any other type of stitch that allows stretching of the seam. In some configurations, a seam can be comprise box or straight stitching.

Hems and trim of a garment can also comprise stitching. Stitching on a hem or trim can be any type of stitch that allows stretching, such as, without limitation, a zig zag stitch, a tricot stitch, a rampart stitch, a ric rac stitch, a stretch hem stitch.

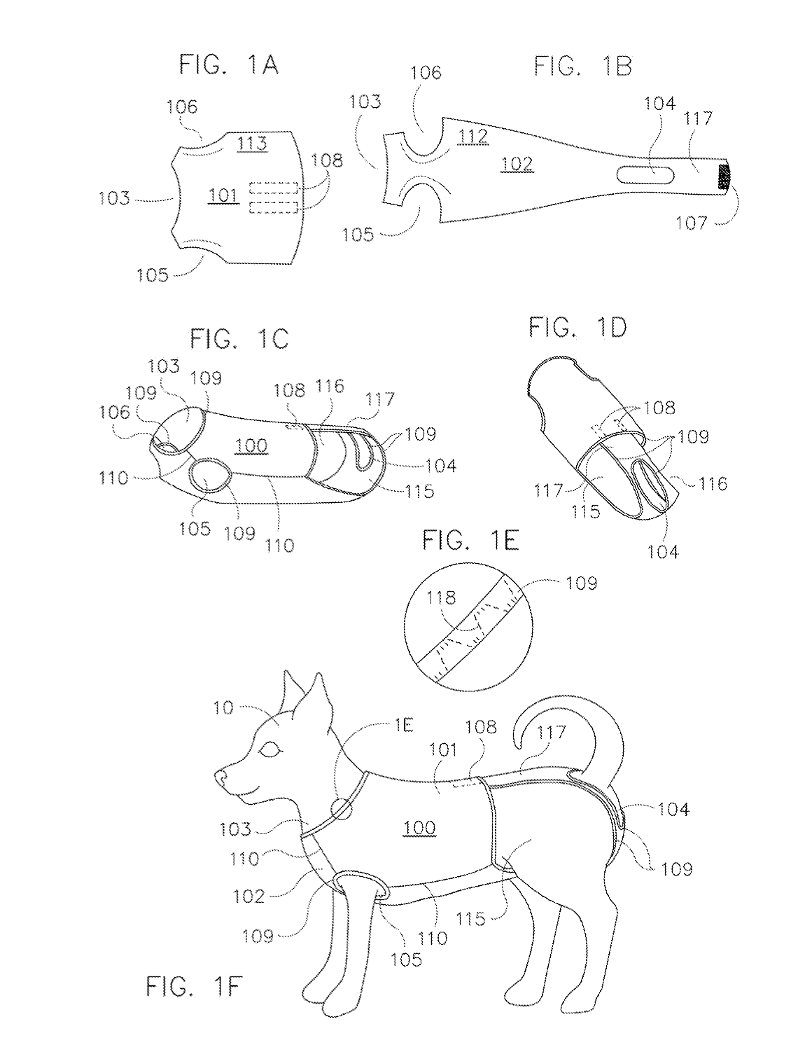

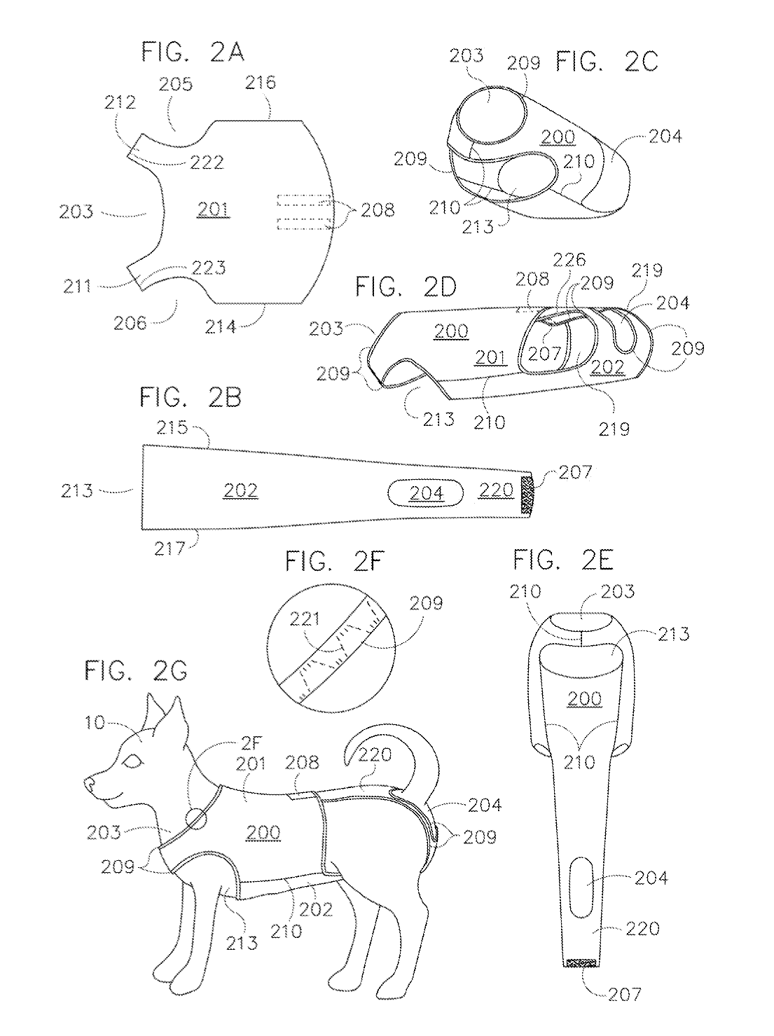

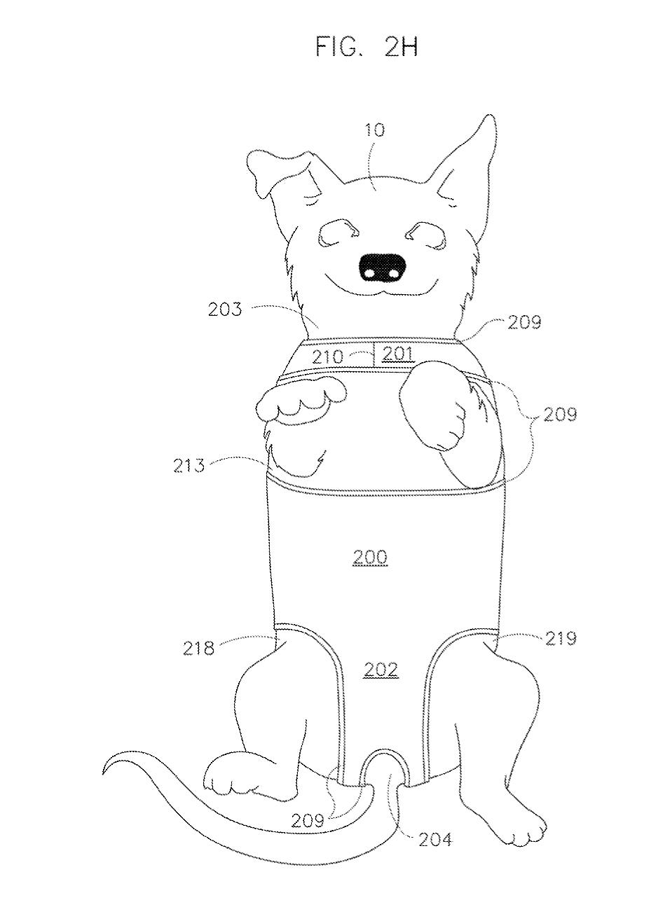

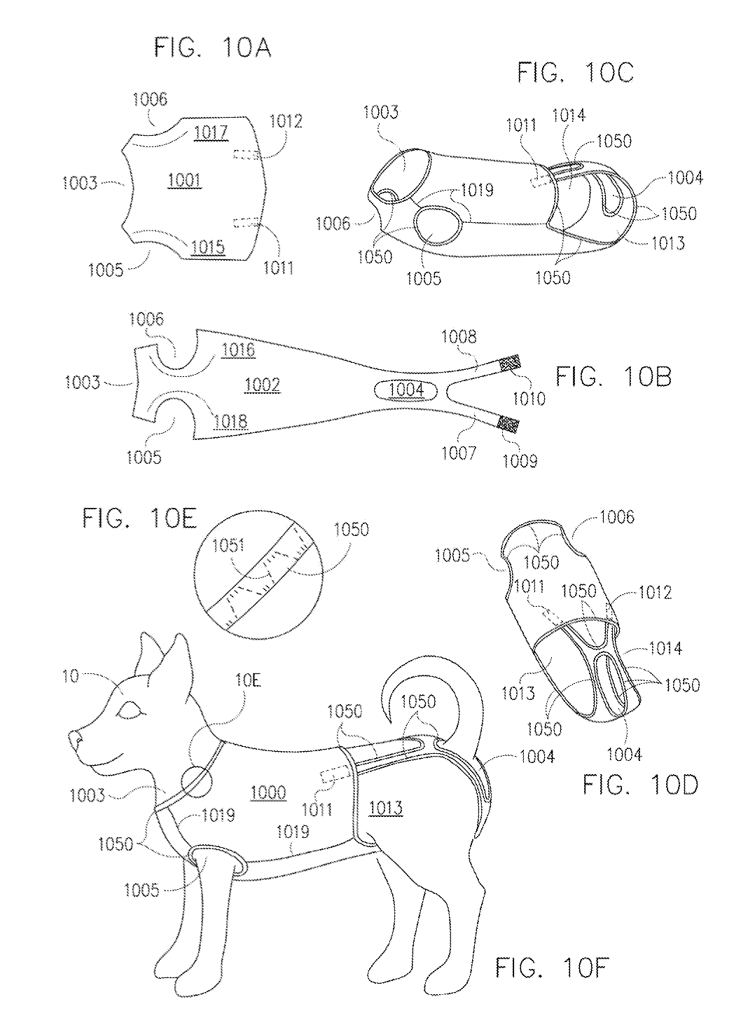

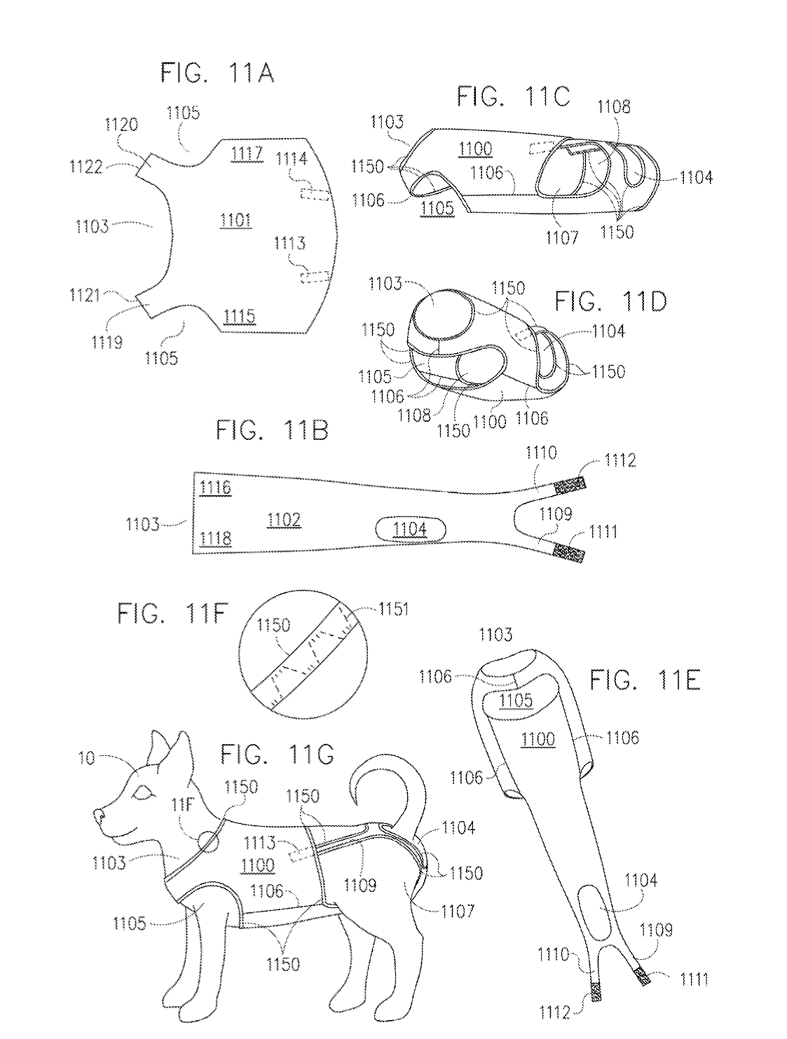

Some embodiments of a garment of the present teachings can be constructed from two or more fabric panels which are subsequently sewn together. FIG. 1A, FIG. 1B, FIG. 2A, FIG. 2B, FIG. 10A, FIG. 10B and FIG. 11A and FIG. 11b, each depict views of exemplary top and bottom panels of embodiments of some garments of the present teachings prior to assembly.

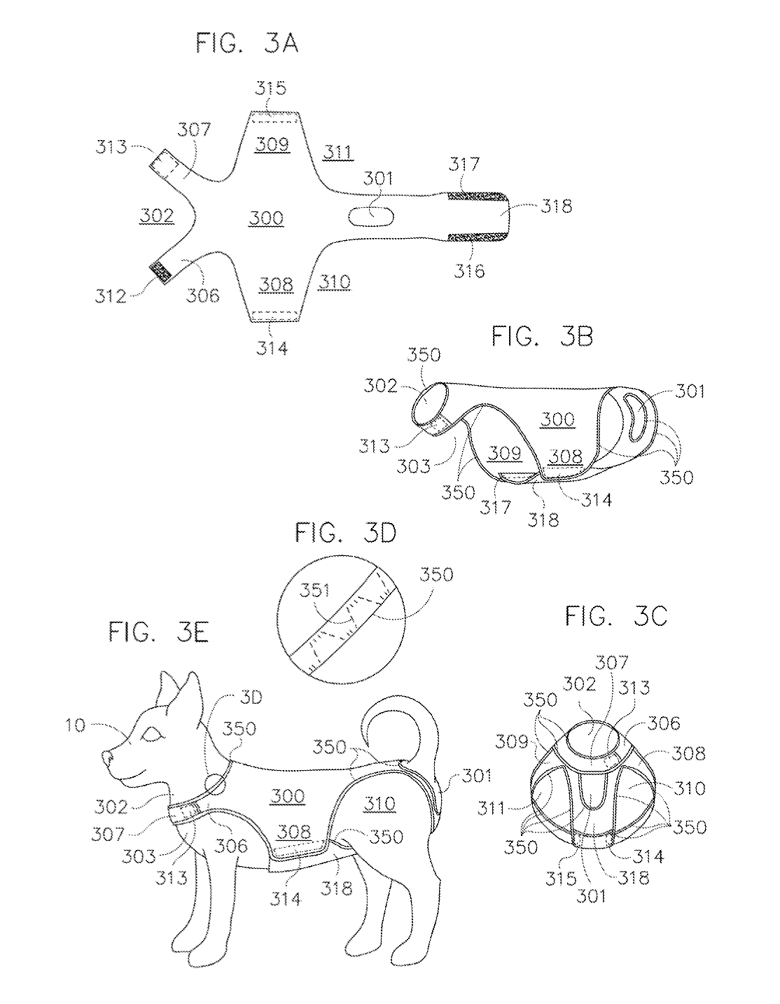

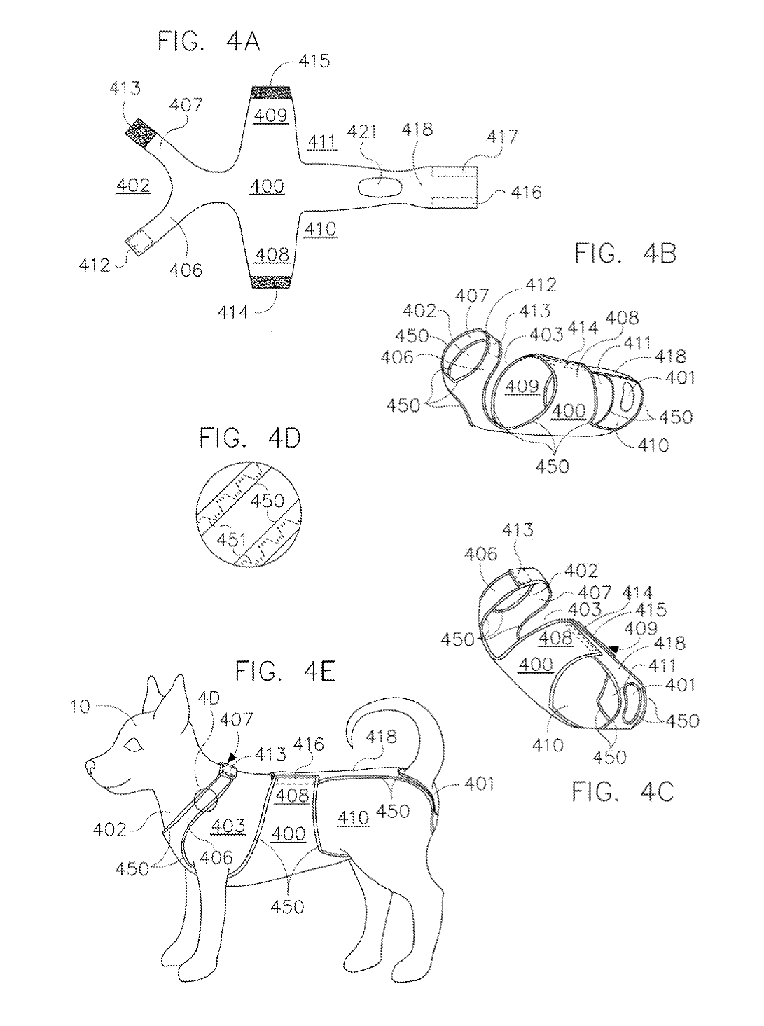

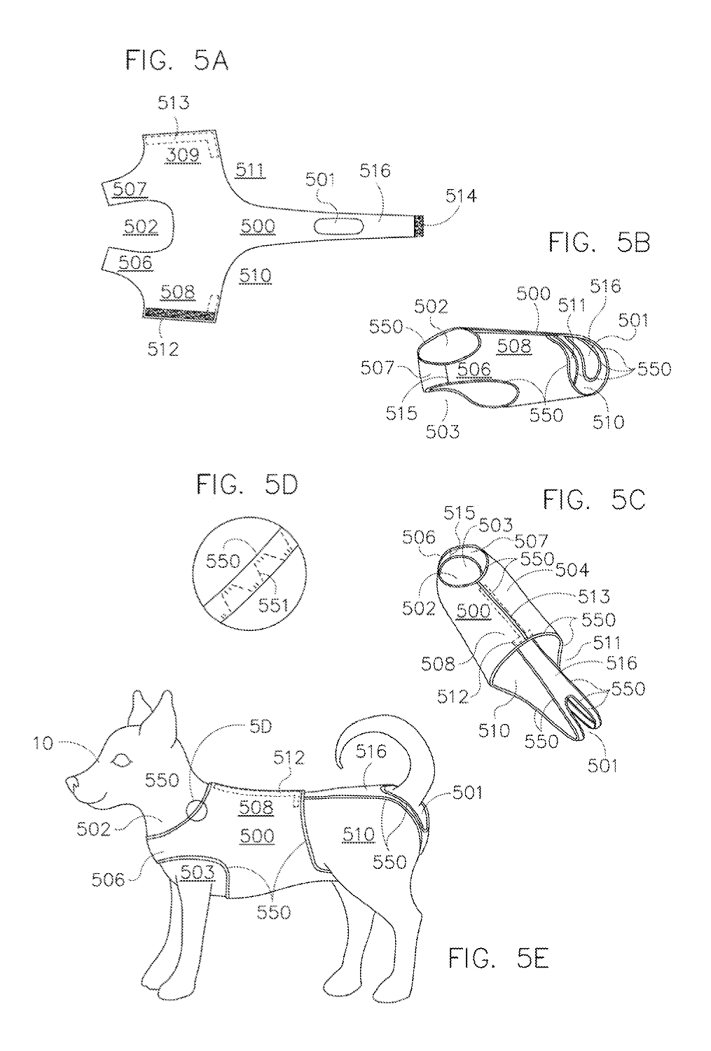

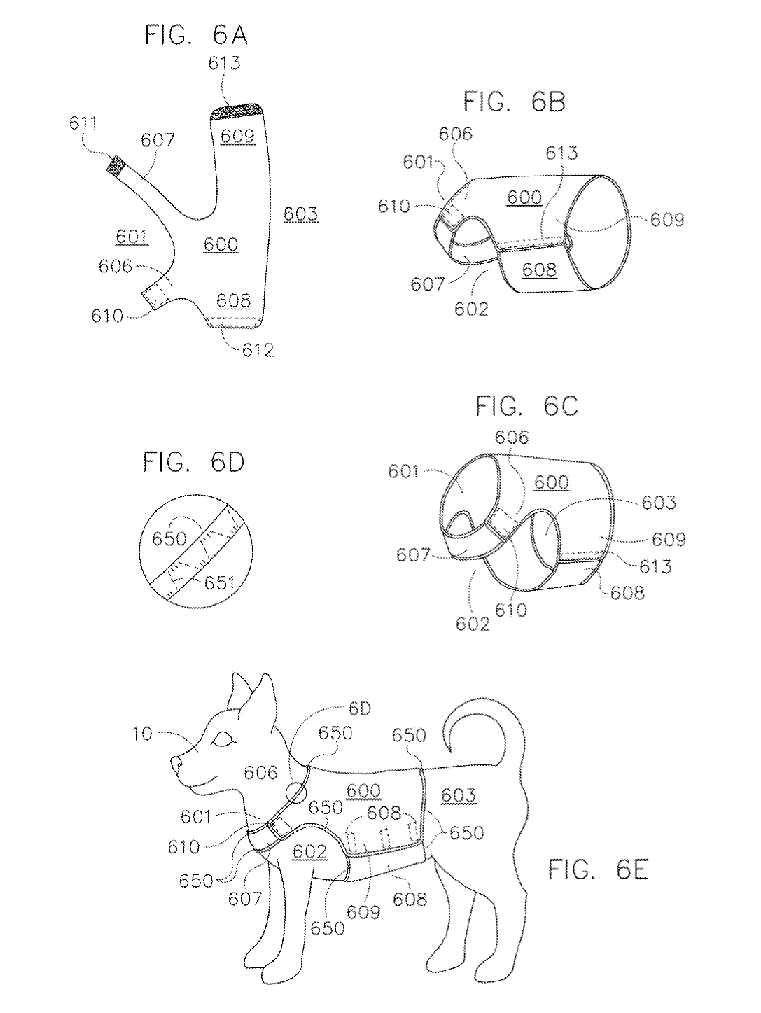

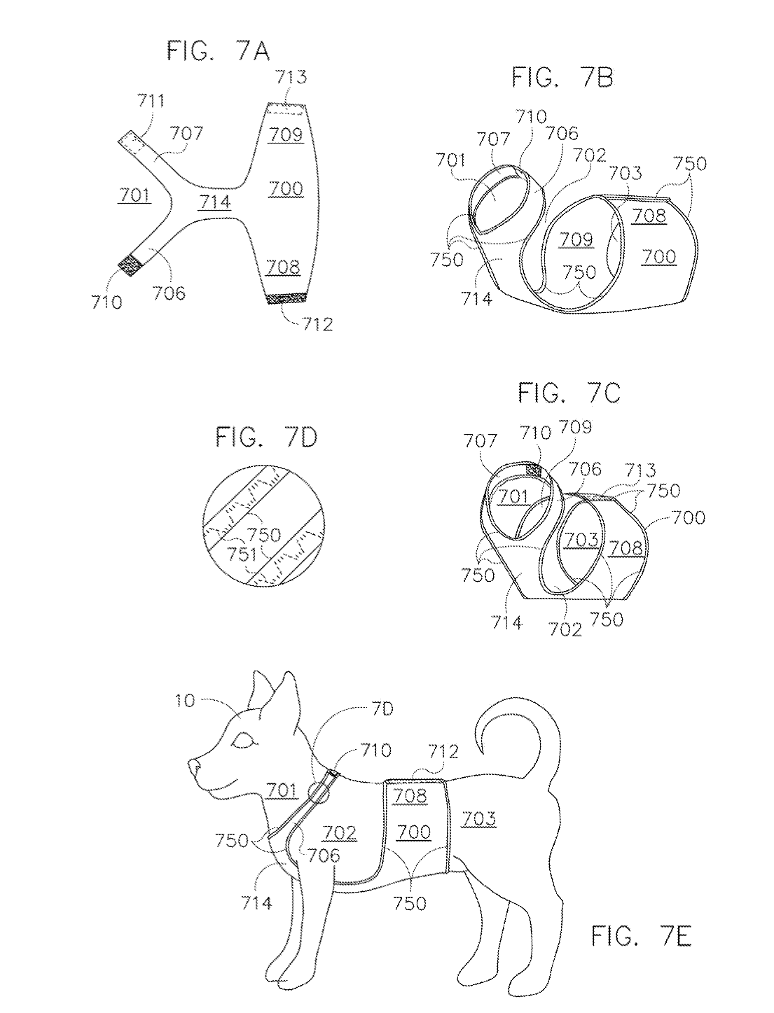

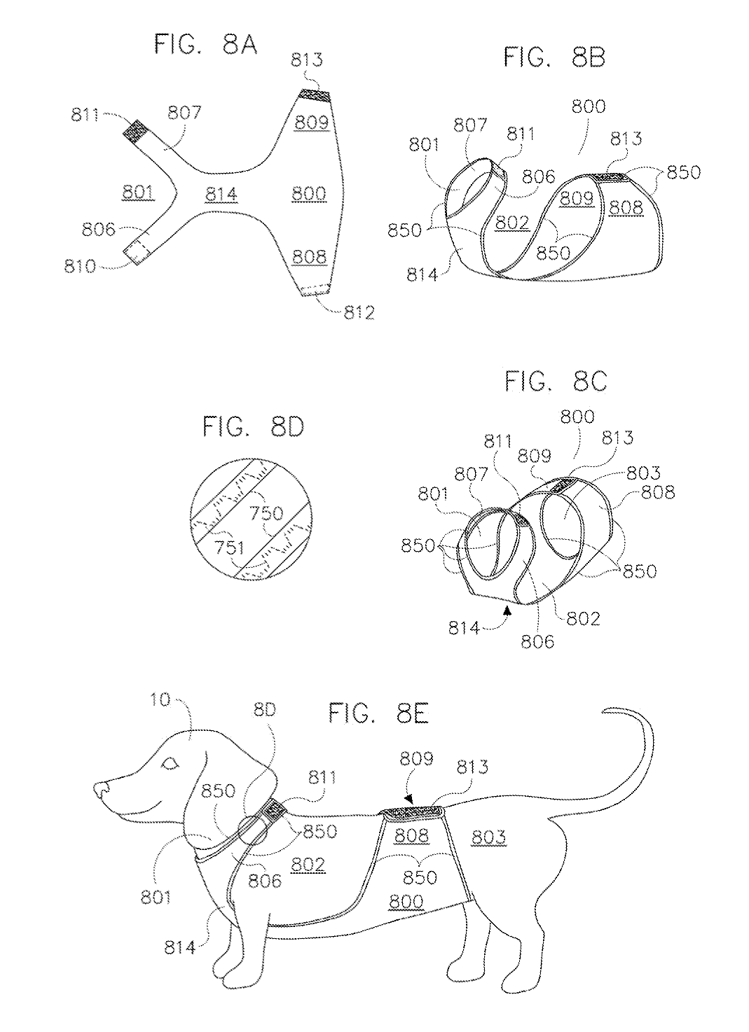

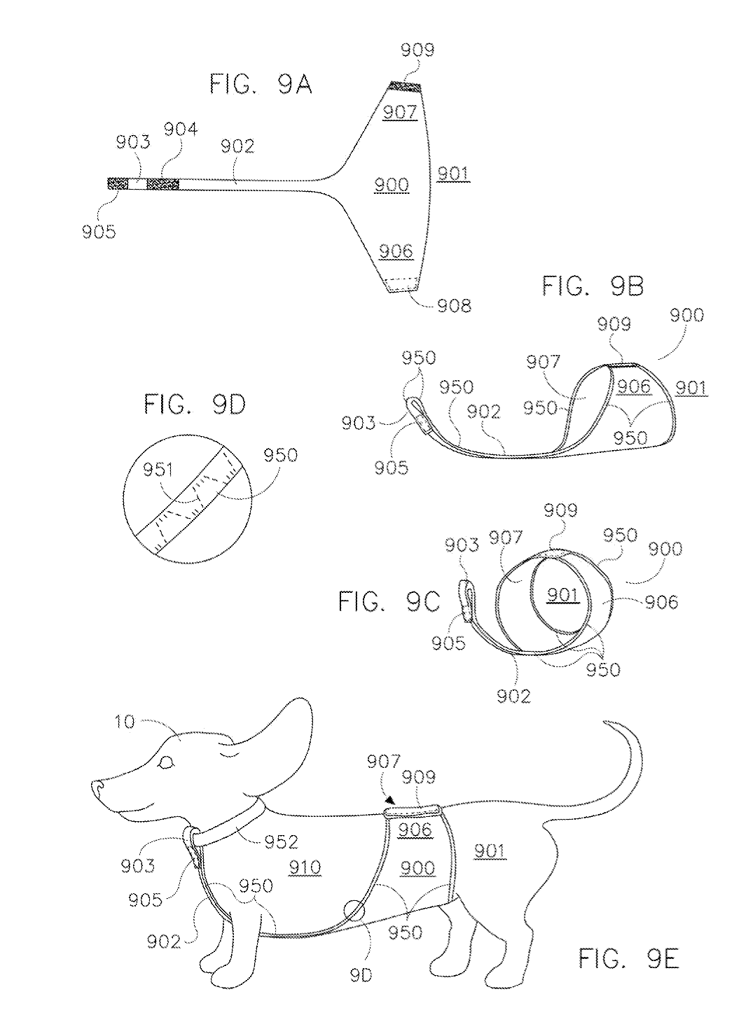

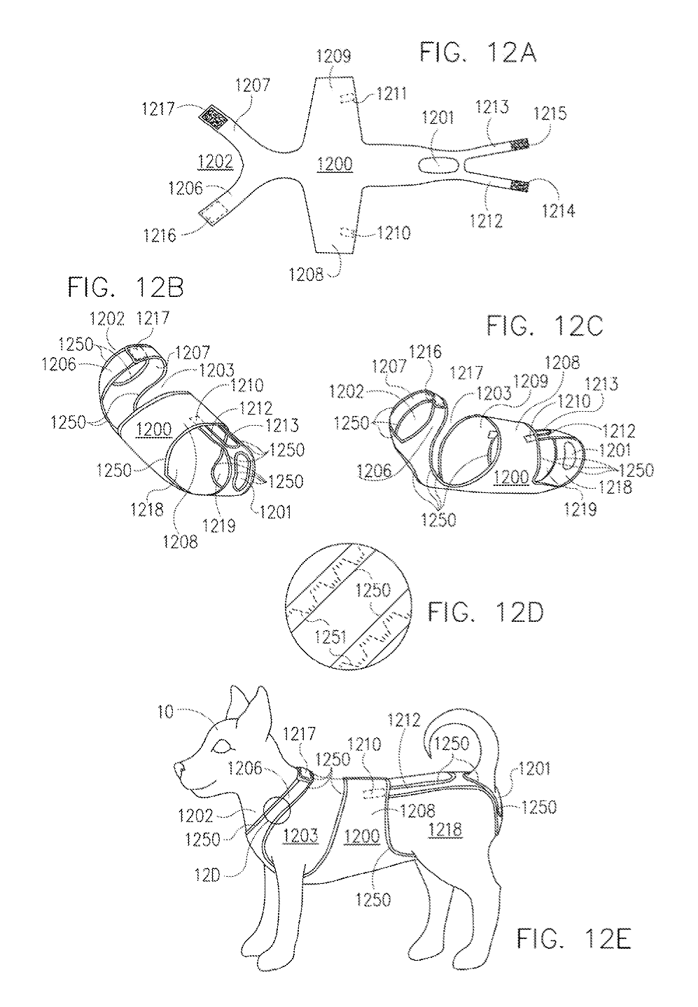

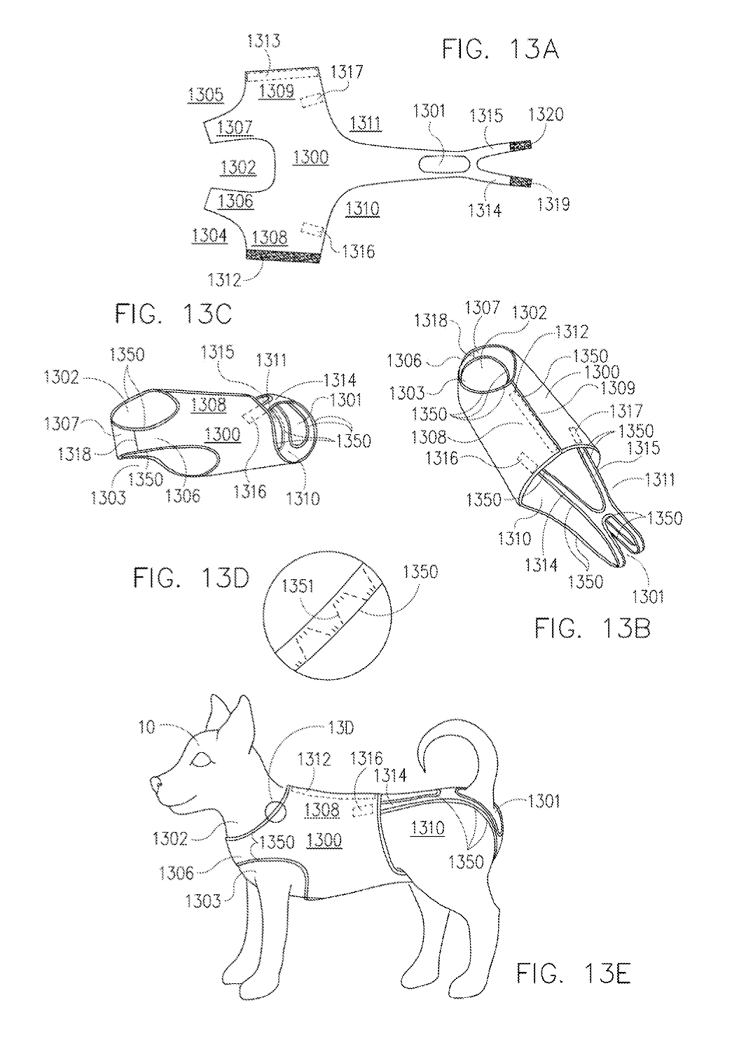

In alternative embodiments, a final garment can comprise only one fabric panel. FIG. 3A, FIG. 4A, FIG. 5A, FIG. 6A, FIG. 7A, FIG. 8A, FIG. 9A, FIG. 12A and FIG. 13a depict exemplary views of a single panel. The remaining views in these figures each depict a complete garment.

Each figure also contains a view of a garment as worn by a mammal. A representative mammal is chosen for depicting the use of the garments; in all figures, a canine mammal 10 is shown.

FIG. 1 depicts an example of one embodiment of the garment 100. FIG. 1A and FIG. 1B each depict a possible panel of the garment 100 before assembly. FIG. 1A depicts a dorsolateral cover portion 101, and FIG. 1B depicts a ventral cover portion 102. The dorsolateral cover portion 101 can comprise one or more attachment portions such as velcro loops 108, and with the ventral cover can define an aperture 105 to receive the animal's left anterior limb, an aperture 106 to receive the animal's right anterior limb, and an aperture 103 to receive the animal's head.

The ventral cover portion 102 covers the animal's abdomen, chest, urogenital region and posterior dorsal region. The ventral cover portion 102 defines an aperture 104 adapted to receive the animal's tail. The ventral cover portion 102 further comprises a portion 117 extending between the portion defining the aperture 104 adapted to receive the animal tail therethrough and the dorsolateral cover portion 101. The ventral cover portion 102 can further comprise one or more attachment portions such as velcro hooks 107. in some configurations, the dorsolateral cover portion 101 can be attached to the ventral cover portion 102 at two seams, such as left seam 110 and a right seam (not shown). The left seam 110 can adjoin fabric section 111 to fabric section 114, and the right seam can adjoin fabric section 113 to fabric section 112. In various configurations, a seam 110 can comprise straight stitching, or can comprise expandable stitching such as stitching 118 shown for trim 109.

Perspective views of dorsolateral cover portion 101 and ventral cover portion 102 are also visible in FIG. 1C, 1D and 1F. When fully assembled, the garment 100 depicted in FIG. 1 further comprises two apertures for receiving the left 115 and right 116 posterior limbs of the animal.

The garment 100 can also comprise trim 109 along the edges, such as depicted in FIG. 1C, FIG. 1D, FIG. 1E and FIG. 1F. The trim 109 can be attached to the garment 100 by any attachment means known to skated artisans, such as stitching 118, FIG. 1E.

FIG. 2 depicts an example of one embodiment of the garment 200. FIG. 2A and FIG. 2B each depict a possible panel of the garment before assembly. FIG. 2A depicts a dorsolateral cover portion 201, and FIG. 2B depicts a ventral cover portion 202. The dorsolateral cover portion 201 can comprise one or more attachment portions such as velcro loops 208, and with the ventral cover can define an aperture 213 to receive the animal's anterior limbs, defined by feature 206 on the left side of the panel and feature 205 on the right side of the panel, and an aperture 203 to receive the animal's head. Features 205 and 206 on the dorsolateral panel 201 are defined by fabric extensions 211 on the left and 212 on the right, respectively.

The ventral cover portion 202 covers the animal's abdomen, chest, urogenital region and posterior dorsal region. The ventral cover portion 202 defines an aperture 204 adapted to receive the animal's tail. The ventral cover portion 202 further comprises a portion 220 extending between the portion defining the aperture 204 adapted to receive the animal tail therethrough and the dorsolateral cover portion. The ventral cover portion 202 can further comprise one or more attachment portions such as velcro hooks 207. In some configurations, the dorsolateral cover portion 201 can be attached to the ventral cover portion 202 at two seams 210. The left seam 210 can adjoin fabric section 214 to fabric section 217, and the right seam can adjoin fabric section 216 to fabric section 215. In further configurations, a seam 210 can adjoin fabric sections 222 and 223 to define an aperture 203. in various configurations, a seam 210 can comprise straight stitching, or can comprise expandable stitching such as stitching 221 shown for trim 209.

Perspective views of dorsolateral cover portion 201 and ventral cover portion 202 are also visible in FIG. 2C, FIG. 2D and FIG. 2F. When fully assembled, the garment 200 depicted in FIG. 2 further comprises two apertures for receiving the left 218 and right 219 posterior limbs of the animal. Elevation view FIG. 2G depicts a ventral view of the fully constructed but unassembled garment 200. FIG. 2H depicts a ventral perspective view of a canine mammal 10 wearing the fully assembled garment 200.

The garment 200 can also comprise trim 209 along the edges, such as depicted in FIG. 2C, FIG. 2D, FIG. 2E, FIG. 2F and FIG. 2H. The trim 209 can be attached to the garment 200 by any attachment means known to skilled artisans, such as stitching 221, FIG. 2E.

FIG. 3 depicts an example of one embodiment of the garment 300. A garment 300 can cover the animal's dorsal, left lateral, right lateral, ventral and urogenital regions. The garment 300 can comprise a dorsal cover portion, a left lateral cover portion 308 and a right lateral cover portion 309. The left lateral cover portion 308 can comprise least one first attachment portion 314, such as velcro hooks. The right lateral cover portion 309 can comprise at least one second attachment portion 315, such as velcro hooks.

The garment 300 can further comprise a left anterior extension 306 comprising at least one left anterior attachment portion 312. The garment 300 can additionally comprise a right anterior extension 307 comprising at least one right anterior attachment portion 313. The left anterior attachment portion 312 can be velcro hooks. The right anterior attachment portion 313 can be velcro loops.

The garment 300 further comprises a posterior extension 318 defining an aperture for receiving the animal tail 301. The posterior extension 318 can further comprise a urogenital cover portion adapted to cover the animal urogenital region, left ventrolateral and right ventrolateral regions, at least one left ventrolateral attachment portion 316, and at least one right ventrolateral attachment portion 317. Both left ventrolateral attachment portion 316, and at least one right ventrolateral attachment portion 317 can be velcro loops.

When left anterior extension 306 and right anterior extension 307 are attached via their attachment portions 312 and 313, respectively, an aperture 302 for receiving the animal's head is thereby created. When left lateral cover portion 308 and right lateral cover portion 309 are additionally attached via their respective attachment portions 314 and 315 to the left and right ventrolateral attachment portions 316 and 317 respectively, three additional apertures are created. Aperture 303 receives the animal's anterior limbs. Aperture 310 receives the animal's left posterior limb. Aperture 311 receives the animal's right posterior limb.

The garment 300 can also comprise trim 350 along the edges, such as depicted in FIG. 3B, FIG. 3C and FIG. 3E. The trim 350 can be attached to the garment 300 by any attachment means known to skilled artisans, such as stitching 351, FIG. 3D.

FIG. 3A depicts an elevation view of the garment in its unassembled state. FIG. 3B, FIG. 3C and FIG. 3E are perspective views of the fully assembled garment 300. FIG. 3E depicts the manner of use of the garment 300 on a mammal, such as a canine mammal 10.

FIG. 4 depicts an embodiment of a garment 400. A garment 400 can comprise a ventral cover adapted for covering the animal's abdomen and chest regions, a left dorsolateral cover 408 comprising at least one first attachment portion 414 and a right dorsolateral cover 409 comprising at least one second attachment portion 415. The attachment portions 414 and 415 can comprise velcro loops.

The garment 400 can further comprise a left anterior extension 406 comprising at least one left anterior attachment portion 412 and a right anterior extension 407 comprising at least one right anterior attachment portion 413. Each anterior extension can extend obliquely from the abdominal cover. The left anterior attachment portion can comprise velcro hooks. The right anterior attachment portion can comprise velcro loops.

The garment 400 can further comprise a posterior extension 418 defining an aperture 401 for receiving the animal tail, a urogenital cover portion adapted to cover the animal urogenital region, and a dorsoposterior portion adapted to cover the animal dorsal posterior region, said dorsoposterior portion comprising at least one left attachment portion 416 and at least one right attachment portion 416. The attachment portions 416 and 417 can comprise velcro hooks.

When fully assembled, the garment 400 can define an aperture 403 for receiving the animal's anterior limbs, and apertures 410 and 411 for receiving the animal's left and right posterior limbs, respectively. The aperture 403 is defined by left anterior extension 406 and right anterior extension 407 together with left dorsolateral cover 408 and right dorsolateral cover 409. The apertures 410 and 411 are defined by left dorsolateral cover 408 and right dorsolateral cover 409 together with posterior extension 418. Furthermore, the anterior extensions 406 and 407, when attached, can define an aperture 402 for receiving the animal's head.

The garment 400 can also comprise trim 450 along the edges, such as depicted in FIG. 4B, FIG. 4C and FIG. 4E. The trim 450 can be attached to the garment 400 by any attachment means known to skilled artisans, such as stitching 451, FIG. 4D.

FIG. 4A depicts an elevation view of the garment 400 in its unassembled state. FIG. 4B, FIG. 4C and FIG. 4E are perspective views of the fully assembled garment 400. FIG. 4E depicts the manner of use of the garment 400 on a mammal, such as a canine mammal 10.

FIG. 5 depicts an embodiment of a garment 500. The garment 500 can comprise a ventral cover, a left dorsolateral cover 508 comprising at least one first attachment portion 512, and a right dorsolateral cover 509 comprising the at least one second attachment portion 513. Both the first attachment portion 512 and the second attachment portion 513 are adapted to the animal dorsal midline.

The garment 500 can further comprise an anterior left extension 506, an anterior right extension 507. In the fully assembled garment, the anterior left extension 506 and the anterior right extension 507 are adjoined by a seam 515.

The garment 500 can further comprise a posterior extension 516 defining an aperture 501 for receiving the animal tail. The posterior extension 516 can comprise a urogenital cover portion adapted to cover the animal urogenital region and a dorsoposterior portion adapted to cover the animal dorsal posterior region, said dorsoposterior portion comprising at least one first dorsoposterior attachment portion 514.

When the garment 500 is fully assembled, the anterior left extension 506 and anterior right extension 507 define an aperture 502 for receiving the animal's head. The anterior left extension 506 and anterior right extension 507 together with the left dorsolateral cover 508 and right dorsolateral cover 509 comprise an aperture 503 for receiving the animal's anterior limbs. The left dorsolateral cover 508 and right dorsolateral cover 509 together with the posterior extension 516 define two apertures 510 and 511 for receiving the animal's left and right posterior limbs, respectively.

The garment 500 can also comprise trim 550 along the edges, such as depicted in FIG. 5B, FIG. 5C and FIG. 5E. The trim 550 can be attached to the garment 500 by any attachment means known to skilled artisans, such as stitching 551, FIG. 5D.

FIG. 5A depicts an elevation view of the garment 500 in its unassembled state. FIG. 5B, FIG. 5C and FIG. 5E are perspective views of the fully assembled garment 500. FIG. 5E depicts the manner of use of the garment 500 on a mammal, such as a canine mammal 10.

FIG. 6-9 depict garments for covering the penis of a male quadruped mammal 10. The garments can comprise a primary portion adapted to both encircle at least a portion of a male mammal's trunk and cover the male mammal's penis. The garments can further comprise at least one first attachment portion and at least one second attachment portion.

FIG. 6 depicts several views of a garment 600. The garment 600 can comprise a primary portion adapted to both encircle at least a portion of a male mammal's trunk and cover the male mammal's penis. The garment 600 can further comprise at least one first attachment portion 612 and at least one second attachment portion 613.

In the garment 600, the at least one first attachment portion 612 is along a first lateral edge 608 of the primary portion; and the at least one second attachment portion 613 is along a second lateral edge 609 of the primary portion.

The garment 600 can further comprise a first extension 606 extending from the primary portion, the first extension comprising at least one third attachment portion 610; and a second extension 607 extending from the primary portion, the second extension comprising at least one fourth attachment portion 611. The first extension 606 and the second extension 607 can be of unequal lengths.

When fully assembled, the garment 600 can further comprise an aperture 601 adapted to receive the male mammal's head and neck. The aperture 601 is created by at least one first attachment comprising the at least one first attachment portion 612 and the at least one second attachment portion 613.

When fully assembled, the garment 600 can further comprise an aperture 602 adapted to receive the male mammal's anterior limbs. The aperture 602 is created by at least one first attachment comprising the at least one first attachment portion 612 and the at least one second attachment portion 613 and at least a second attachment comprising the at least one third attachment portion 610 and the at least one fourth attachment portion 611.

When fully assembled, the garment 600 can further comprise an aperture 603 adapted to receive the male mammal's posterior limbs. The aperture is created by at least a second attachment comprising the at least one third attachment portion 610 and the at least one fourth attachment portion 611.

The garment 600 can also comprise trim 650 along the edges, such as depicted in FIG. 6B, FIG. 6C and FIG. 6E. The trim 650 can be attached to the garment 600 by any attachment means known to skilled artisans, such as stitching 651, FIG. 6D.

FIG. 6A depicts an elevation view of the garment 600 in its unassembled state. FIG. 6B, FIG. 6C and FIG. 6E are perspective views of the fully assembled garment 600. FIG. 6E depicts the manner of use of the garment 600 on a mammal, such as a canine mammal 10.

FIG. 7 depicts several views of a garment 700. The garment 700 can comprise a primary portion adapted to both encircle at least a portion of a male mammal's trunk and cover the male mammal's penis. The garment 700 can further comprise at least one first attachment portion 712 and at least one second attachment portion 713.

In the garment 700, the at least one first attachment portion 712 is along a first lateral edge 708 of the primary portion; and the at least one second attachment portion 713 is along a second lateral edge 709 of the primary portion.

The garment 700 can further comprise a first extension 706 extending from the primary portion, the first extension comprising at least one third attachment portion 710: and a second extension 707 extending from the primary portion, the second extension comprising at least one fourth attachment portion 711. The first extension 706 and the second extension 707 can be of equal lengths.

When fully assembled, the garment 700 can further comprise an aperture 701 adapted to receive the male mammal's head and neck. The aperture 701 is created by at least one first attachment comprising the at least one first attachment portion 712 and the at least one second attachment portion 713.

When fully assembled, the garment 700 can further comprise an aperture 702 adapted to receive the male mammal's anterior limbs. The aperture 702 is created by at least one first attachment comprising the at least one first attachment portion 712 and the at least one second attachment portion 713 and at least a second attachment comprising the at least one third attachment portion 710 and the at least one fourth attachment portion 711.

When fully assembled, the garment 700 can further comprise an aperture 703 adapted to receive the male mammal's posterior limbs. The aperture is created by at least a second attachment comprising the at least one third attachment portion 710 and the at least one fourth attachment portion 711.

The garment 700 further comprises a section 714 which, when the garment 700 is fully assembled and used on an animal, is situated under the animal's chest.

The garment 700 can also comprise trim 750 along the edges, such as depicted in FIG. 7B, FIG. 7C and FIG. 7E. The trim 750 can be attached to the garment 700 by any attachment means known to skilled artisans, such as stitching 751, FIG. 7D.

FIG. 7A depicts an elevation view of the garment 700 in its unassembled state. FIG. 7B, FIG. 7C and FIG. 7E are perspective views of the fully assembled garment 700. FIG. 7E depicts the manner of use of the garment on a mammal, such as a canine mammal 10.

FIG. 8 depicts several views of a garment 800 for use on a substantially elongated animal, such as a dachshund breed of dog. The garment 800 can comprise a primary portion adapted to both encircle at least a portion of a male mammal's trunk and cover the male mammal's penis. The garment 800 can further comprise at least one first attachment portion 812 and at least one second attachment portion 813.

In the garment 800, the at least one first attachment portion 812 is along a first lateral edge 808 of the primary portion; and the at least one second attachment portion 813 is along a second lateral edge 809 of the primary portion.

The garment 800 can further comprise a first extension 806 extending from the primary portion, the first extension comprising at least one third attachment portion 810; and a second extension 807 extending from the primary portion, the second extension comprising at least one fourth attachment portion 811. The first extension 806 and the second extension 807 can be of equal lengths.

When fully assembled, the garment 800 can further comprise an aperture 801 adapted to receive the male mammal's head and neck. The aperture 801 is created by at least one first attachment comprising the at least one first attachment portion 812 and the at least one second attachment portion 813.

When fully assembled, the garment 800 can further comprise an aperture 802 adapted to receive the male mammal's anterior limbs. The aperture 802 is created by at least one first attachment comprising the at least one first attachment portion 812 and the at least one second attachment portion 813 and at least a second attachment comprising the at least one third attachment portion 810 and the at least one fourth attachment portion 811.

When fully assembled, the garment 800 can further comprise an aperture 803 adapted to receive the male mammal's posterior limbs. The aperture is created by at least a second attachment comprising the at least one third attachment portion 810 and the at least one fourth attachment portion 811.

The garment 800 further comprises a section 814 which, when the garment 800 is fully assembled and used on an animal, is situated under the animal's chest.

The garment 800 can also comprise trim 850 along the edges, such as depicted in FIG. 8B, FIG. 8C and FIG. 8E. The trim 850 can be attached to the garment 800 by any attachment means known to skilled artisans, such as stitching 851, FIG. 8D.

FIG. 8A depicts an elevation view of the garment 800 in its unassembled state. FIG. 8B, FIG. 8C and FIG. 8E are perspective views of the fully assembled garment 800. FIG. 8E depicts the manner of use of the garment 800 on a substantially elongated mammal, such as a canine mammal 10.

FIG. 9 depicts several views of a garment 900 for use on a substantially elongated animal, such as a dachshund breed of dog. The garment 900 can comprise a primary portion adapted to both encircle at least a portion of a male mammal's trunk and cover the male mammal's penis. The garment 900 can further comprise at least one first attachment portion 908 and at least one second attachment portion 909.

In the garment 900, the at least one first attachment portion 908 is along a first lateral edge 906 of the primary portion; and the at least one second attachment portion 909 is along a second lateral edge 907 of the primary portion.

The garment 900 can further comprise an extension 902 adapted to extend anteriorly over the animal ventral region. The extension 902 can further comprise at least one third attachment portion 904 and at least one fourth attachment portion 905.

In the garment 900, at least one anterior attachment comprising the at least one third attachment portion 904 and the at least one fourth attachment portion 905 can form a loop 903 adapted to secure the extension to an animal neck collar 952.

When the garment 900 is fully assembled on an animal, two apertures 901 and 910 are created. The animal's anterior limbs straddle extension 902 and the anterior limbs and and anterior aperture 910 is for receiving the animal's anterior limbs and head/neck. Aperture 903 is for receiving the animal's posterior limbs and tail.

The garment 900 can also comprise trim 950 along the edges, such as depicted in FIG. 9B, FIG. 9C and FIG. 9E. The trim 950 can be attached to the garment 900 by any attachment means known to skilled artisans, such as stitching 951, FIG. 9D.

FIG. 9A depicts an elevation view of the garment 900 in its unassembled state. FIG. 9B, FIG. 9C and FIG. 9E are perspective views of the fully assembled garment 900. FIG. 9E depicts the manner of use of the garment 900 on a substantially elongated mammal, such as a canine mammal 10.

FIG. 10 depicts an example of one embodiment of the garment 1000. FIG. 10A and FIG. 10B each depict a possible panel of the garment before assembly. FIG. 10A depicts a dorsolateral cover portion 1001, and FIG. 10B depicts a ventral cover portion 1002. The dorsolateral cover portion 1001 can comprise one or more attachment portions such as velcro loops 1011, and with the ventral cover can define an aperture 1005 to receive the animal's left anterior limb, an aperture 1006 to receive the animal's right anterior limb, and an aperture 1003 to receive the animal's head.

The ventral cover portion 1002 covers the animal's abdomen, chest, urogenital region and posterior dorsal region. The ventral cover portion 1002 defines an aperture 1004 adapted to receive the animal's tail. The ventral cover portion 1002 further comprises a posterior extension. The posterior extension can comprise a first subsection comprising the urogenital cover and the portion defining the aperture adapted to receive the animal tail therethrough, and a plurality of additional subsections, each additional subsection extending from the portion defining the aperture to the dorsolateral cover, and wherein each additional subsection comprises at least one attachment portion. The posterior extension of the ventral cover portion 1002 can comprise a first subsection comprising the urogenital cover and the portion defining the aperture, a left subsection 1007 extending from the portion defining the aperture to the left lateral cover, and a right subsection 1008 extending from the portion defining the aperture to the right lateral cover. Each of the left subsection and the right subsection can comprise at least one attachment portion, 1009 and 1010, respectively.

The ventral cover portion 1002 can further comprise one or more attachment portions such as velcro hooks 1011 and 1012. In some configurations, the dorsolateral cover portion 1001 can be attached to the ventral cover portion 1002 at two seams, such as left seam 1019 and a right seam (not shown). The left seam 1019 can adjoin fabric section 1015 to fabric section 1018, and the right seam can adjoin fabric section 1017 to fabric section 1016. In various configurations, a seam can comprise straight stitching, or can comprise expandable stitching such as stitching 1051 shown for trim 1050.

Perspective views of dorsolateral cover portion 1001 and ventral cover portion 1002 are also visible in FIG. 10C, 10D and 10F. When fully assembled the garment 1000 defines an aperture 1003 for receiving the animal's head/neck. When fully assembled, the garment 1000 depicted in FIG. 10 can define two apertures for receiving the left 1005 and right 1005 anterior limbs of the animal. When fully assembled, the garment 1000 depicted in FIG. 10 can further define two apertures for receiving the left 1013 and right 1014 posterior limbs of the animal.

The garment 1009 can also comprise trim 1050 along the edges, such as depicted in FIG. 10C, FIG. 10D, FIG. 10E and FIG. 10F. The trim 1050 can be attached to the garment 1000 by any attachment means known to skilled artisans, such as stitching 1051, FIG. 10E.

FIG. 11 depicts an example of one embodiment of the garment 1100. FIG. 11A and FIG. 11B each depict a possible panel of the garment 1100 before assembly. FIG. 11A depicts a dorsolateral cover portion 1101, and FIG. 11B depicts a ventral cover portion 1102. The dorsolateral cover portion 1101 can comprise one or more attachment portions such as velcro loops 1113 and 1114, and with the ventral cover can define an aperture 1105 to receive the animal's anterior limbs, defined by feature 1119 on the left side of the panel and feature 1120 on the right side of the panel, and an aperture 1103 to receive the animal's head.

The ventral cover portion 1102 covers the animal's abdomen, chest, urogenital region and posterior dorsal region. The ventral cover portion 1102 defines an aperture 1104 adapted to receive the animal's tail. The posterior extension can comprise a first subsection comprising the urogenital cover and the portion defining the aperture adapted to receive the animal tail therethrough, and a plurality of additional subsections, each additional subsection extending from the portion defining the aperture to the dorsolateral cover, and wherein each additional subsection comprises at least one attachment portion. The posterior extension of the ventral cover portion 1102 can comprise a first subsection comprising the urogenital cover and the portion defining the aperture, a left subsection 1109 extending from the portion defining the aperture to the left lateral cover, and a right subsection 1110 extending from the portion defining the aperture to the right lateral cover. Each of the left subsection and the right subsection can comprise at least one attachment portion, 1111 and 1112, respectively.

In some configurations, the dorsolateral cover portion 1101 can be attached to the ventral cover portion 1102 at two seams 1106. The left seam 1106 can adjoin fabric section 1115 to fabric section 1118, and the right seam can adjoin fabric section 1116 to fabric section 1116. In further configurations, the dorsolateral cover portion 1101 can be shaped by placing a seam 1106 in such a way as to adjoin fabric sections 1121 and 1122. In various configurations, a seam 1106 can comprise straight stitching, or can comprise expandable stitching such as stitching 1151 shown for trim 1150.

Perspective views of dorsolateral cover portion 1101 and ventral cover portion 1102 are also visible in FIG. 11C, FIG. 11D and FIG. 11F. When fully assembled, the garment 1100 depicted in FIG. 11 further comprises two apertures for receiving the left 1107 and right 1108 posterior limbs of the animal. Elevation view FIG. 11G depicts a ventral view of the fully constructed but unassembled garment 1100. FIG. 11H depicts a ventral perspective view of a canine mammal 10 wearing the fully assembled garment 1100.

The garment 1100 can also comprise trim 1150 along the edges, such as depicted in FIG. 11C, FIG. 11D, FIG. 11E, FIG. 11F and FIG. 11H. The trim 1150 can be attached to the garment 1100 by any attachment means known to skilled artisans, such as stitching 1151, FIG. 11E.

FIG. 12 depicts an embodiment of a garment 1200. A garment 1200 can comprise a ventral cover adapted for covering the animal's abdomen and chest regions, a left dorsolateral cover 1208 and a right dorsolateral cover 1209.

The garment 1200 can further comprise a left anterior extension 1206 comprising at least one left anterior attachment portion 1216 and a right anterior extension 1207 comprising at least one right anterior attachment portion 1217. Each anterior extension can extend obliquely from the abdominal cover. The left anterior attachment portion can comprise velcro hooks. The right anterior attachment portion can comprise velcro loops.

The garment 1200 can further comprise a posterior extension defining an aperture 1201 for receiving the animal tail, a urogenital cover portion adapted to cover the animal urogenital region, and a dorsoposterior portion adapted to cover the animal dorsal posterior region. The posterior extension can comprise a plurality of additional subsections, each additional subsection extending from the portion defining the aperture to the dorsolateral cover, and wherein each additional subsection comprises at least one attachment portion. The posterior extension can comprise a left subsection 1212 extending from the portion defining the aperture 1201 to the left lateral cover, and a right subsection 1213 extending from the portion defining the aperture 1201 to the right lateral cover. Each of the left subsection and the right subsection can comprise at least one attachment portion, 1214 and 1215, respectively.

When fully assembled, the garment 1200 can define an aperture 1203 for receiving the animal's anterior limbs, and apertures 1218 and 1219 for receiving the animal's left and right posterior limbs, respectively. The aperture 1203 is defined by left anterior extension 1206 and right anterior extension 1207 together with left dorsolateral cover 1208 and right dorsolateral cover 1209. The apertures 1218 and 1219 are defined by left dorsolateral cover 1208 and right dorsolateral cover 1209 together with the posterior extension. Furthermore, the anterior extensions 1206 and 1207, when attached, can define an aperture 1202 for receiving the animal's head.

The garment 1200 can also comprise trim 1250 along the edges, such as depicted in FIG. 12B, FIG. 12C and FIG. 12E. The trim 1250 can be attached to the garment 1200 by any attachment means known to skilled artisans, such as stitching 1251, FIG. 12D.

FIG. 12A depicts an elevation view of the garment 1200 in its unassembled state. FIG. 12B, FIG. 12C and FIG. 12E are perspective views of the fully assembled garment 1200. FIG. 12E depicts the manner of use of the garment 1200 on a mammal, such as a canine mammal 10.

FIG. 13 depicts an embodiment of a garment 1300. The garment 1300 can comprise a ventral cover, a left dorsolateral cover 1308 comprising at least one first attachment portion 1312, and a right dorsolateral cover 1309 comprising the at least one second attachment portion 1313. Both the first attachment portion 1312 and the second attachment portion 1313 are adapted to the animal dorsal midline.

The garment 1300 can further comprise an anterior left extension 1306, an anterior right extension 1307. In the fully assembled garment, the anterior left extension 1306 and the anterior right extension 1307 are adjoined by a seam 1318.

The garment 1300 can further comprise a posterior extension defining an aperture 1301 for receiving the animal tail. The posterior extension can comprise a urogenital cover portion adapted to cover the animal urogenital region and a dorsoposterior portion adapted to cover the animal dorsal posterior region. The posterior extension can comprise a left subsection 1314 extending from the portion defining the aperture 1301 to the left lateral cover, and a right subsection 1314 extending from the portion defining the aperture 1301 to the right lateral cover. Each of the left subsection and the right subsection can comprise at least one attachment portion, 1316 and 1317, respectively.

When the garment 1300 is fully assembled, the anterior left extension 1306 and anterior right extension 1307 define an aperture 1302 for receiving the animal's head. The anterior left extension 1306 and anterior right extension 1307 together with the left dorsolateral cover 1308 and right dorsolateral cover 1309 comprise an aperture 1303 for receiving the animal's anterior limbs. The left dorsolateral cover 1308 and right dorsolateral cover 1309 together with the posterior extension 1316 define two apertures 1310 and 1311 for receiving the animal's left and right posterior limbs, respectively.

The garment 1300 can also comprise trim 1350 along the edges, such as depicted in FIG. 13B, FIG. 13C and FIG. 13E. The trim 1350 can be attached to the garment 1300 by any attachment means known to skilled artisans, such as stitching 1351, FIG. 13D.

FIG. 13A depicts an elevation view of the garment 1300 in its unassembled state. FIG. 13B, FIG. 13C and FIG. 13E are perspective views of the fully assembled garment 1300. FIG. 13E depicts the manner of use of the garment 1300 on a mammal, such as a canine mammal 10.

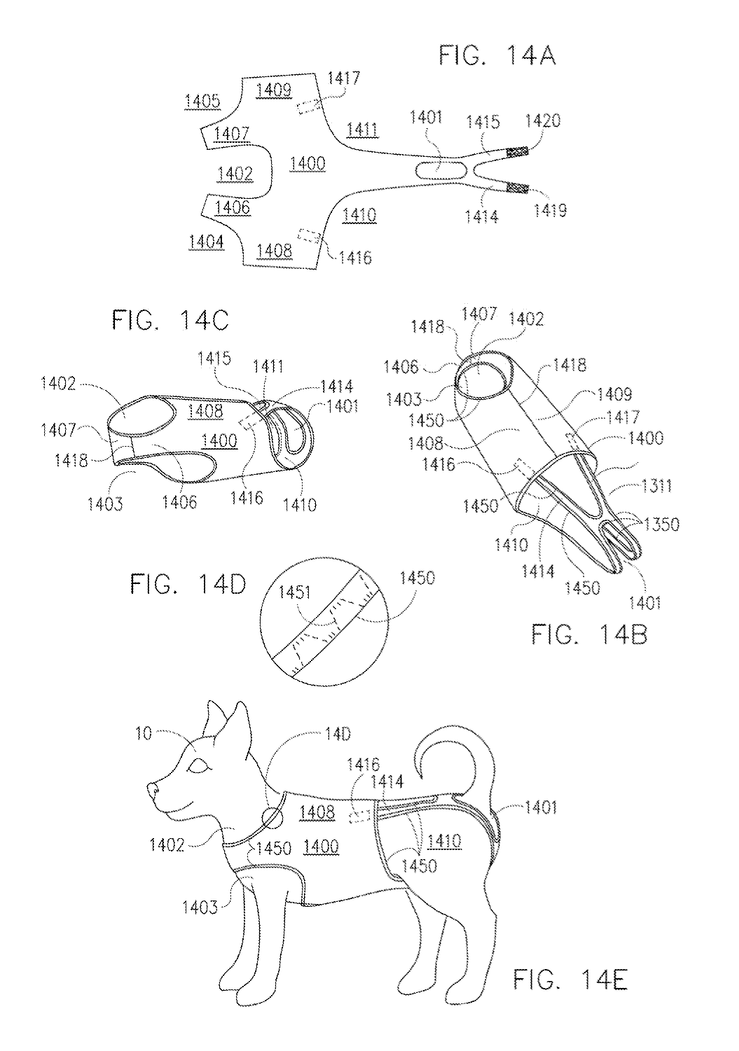

FIG. 14 depicts an embodiment of a garment 1400. The garment 1400 can comprise a ventral cover, a left dorsolateral cover 1408 and a right dorsolateral cover 1409. A seam 1418 can attach fabric sections 1412 and 1413 at the dorsal midline.

The garment 1400 can further comprise an anterior left extension 1406, an anterior right extension 1407. In the fully assembled garment 1400, the anterior left extension 1406 and the anterior right extension 1407 can be adjoined by a seam 1418.

The garment 1400 can further comprise a posterior extension defining an aperture 1401 for receiving the animal tail. The posterior extension can comprise a urogenital cover portion adapted to cover the animal urogenital region and a dorsoposterior portion adapted to cover the animal dorsal posterior region. The posterior extension can comprise a left subsection 1414 extending from the portion defining the aperture 1401 to the left lateral cover, and a right subsection 1414 extending from the portion defining the aperture 1401 to the right lateral cover. Each of the left subsection and the right subsection can comprise at least one attachment portion, 1416 and 1417, respectively.

When the garment 1400 is fully assembled, the anterior left extension 1406 and anterior right extension 1407 can define an aperture 1402 for receiving the animal's head. The anterior left extension 1406 and anterior right extension 1407 together with the left dorsolateral cover 1408 and right dorsolateral cover 1409 can comprise an aperture 1403 for receiving the animal's anterior limbs. The left dorsolateral cover 1408 and right dorsolateral cover 1409 together with the posterior extension 1416 can define two apertures 14.10 and 1411 for receiving the animal's left and right posterior limbs; respectively.

The garment 1400 can also comprise trim 1450 along the edges, such as depicted in FIG. 14B, FIG. 14C and FIG. 14E. The trim 1450 can be attached to the garment 1400 by any attachment means known to skilled artisans, such as stitching 1451, FIG. 14D.

FIG. 14A depicts an elevation view of the garment 1400 in its unassembled state. FIG. 14B, FIG. 14C and FIG. 14E are perspective views of the fully assembled garment 1400. FIG. 14E depicts the manner of use of the garment 1400 on a mammal, such as a canine mammal 10.

The present disclosure includes the following aspects.

1. A garment adapted for covering the urogenital region of a quadruped animal, comprising at least one urogenital cover, at least one first attachment portion and at least one second attachment portion.

2. A garment in accordance with aspect 1, wherein the quadruped animal is a mammal.

3. A garment in accordance with aspect 1, wherein the quadruped animal is a male quadruped animal.

4. A garment in accordance with aspect 1, wherein the quadruped animal is a female quadruped animal.

5. A garment in accordance with aspect 2, wherein the mammal is selected from the group consisting of a canine mammal, a feline mammal, an ovine mammal, a bovine mammal, a porcine mammal, a caprine mammal, an equine mammal, and a leporine mammal.

6. A garment in accordance with aspect 2, wherein the mammal is a canine mammal.

7. A garment in accordance with aspect 1, comprising an elastomeric material.

8. A garment in accordance with aspect 7, wherein the elastomeric material has a low coefficient of friction.

9. A garment in accordance with aspect 7, wherein the elastomeric material is spandex.

10. A garment in accordance with aspect 7, further comprising trim along at least one edge of said garment.

11. A garment in accordance with aspect 10, wherein the trim comprises an elastomeric material.

12. A garment in accordance with aspect 11, wherein the elastomeric material has a low coefficient of friction.

13. A garment in accordance with aspect 11, wherein the elastomeric material is spandex.

14. A garment in accordance with aspect 10, wherein the trim is attached along the at least one edge by at least one stretchable attachment.

15. A garment in accordance with aspect 14, wherein the at least one stretchable attachment comprises expandable stitching.

16. A garment in accordance with aspect 10,wherein the trim is attached to the at least one edge by transversely alternating stitching.

17. A garment in accordance with aspect 1, further comprising at least one absorbent pad adjacent to the urogenital cover.

18. A garment in accordance with aspect 17, wherein the at least one absorbent pad is adhered to the urogenital cover.

19. A garment in accordance with aspect 17, wherein the at least one absorbent pad is reversibly adhered to the urogenital cover.

20. A garment in accordance with aspect 17, wherein the at least one absorbent pad is adapted to be positioned adjacent to the animal urogenital region.

21. A garment in accordance with aspect 1, comprising
a dorsolateral cover portion comprising a dorsal cover adapted for covering the animal's dorsal region, a left lateral cover adapted for covering the animal's left lateral region and a right lateral cover adapted for covering the animal's right lateral region; and
a ventral cover portion extending between the left lateral cover and the right lateral cover and further comprising a urogenital cover adapted for covering the animal's urogenital region.

22. A garment in accordance with aspect 21, further comprising at least one posterior extension extending from the urogenital cover portion.

23. A garment in accordance with aspect 22, wherein the at least one posterior extension further comprises a portion defining an aperture adapted to receive the animal tail therethrough.

24. A garment in accordance with aspect 23, wherein the at least one posterior extension further comprises a portion extending between the portion defining an aperture adapted to receive the animal tail therethrough and the dorsolateral cover portion.

25. A garment in accordance with aspect 23, wherein the at least one posterior extension is adapted for covering the animal dorsal posterior region

26. A garment in accordance with aspect 22, wherein the at least one posterior extension further comprises the at least one first attachment portion and the dorsolateral cover portion comprises the at least one second attachment portion.

27. A garment in accordance with aspect 26, comprising at least one attachment comprising the at least one first attachment portion and the at least one second attachment portion.

28. A garment in accordance with aspect 27, wherein the at least one attachment is at least one reversible attachment.

29. A garment in accordance with aspect 28, wherein the at least one reversible attachment is selected from the group consisting of at least one velcro attachment, at least one button/buttonhole; at least one hook/eye, at least one snap, at least one zipper, and a combination thereof.

30. A garment in accordance with aspect 28, wherein the at least one reversible attachment is at least one velcro attachment.

31. A garment in accordance with aspect 29, wherein the at least one attachment attaches the posterior extension to the dorsal cover.

32. A garment in accordance with aspect 21, further comprising a chest cover adapted for covering the animal chest region.

33. A garment in accordance with aspect 21, wherein the garment further defines a head aperture adapted to receive the animal head therethrough.

34. A garment in accordance with aspect 21, wherein the garment further defines a first aperture adapted to receive the animal left anterior leg therethrough and a second aperture adapted to receive the animal right anterior leg therethrough.

35. A garment in accordance with aspect 21, wherein the garment further defines an aperture adapted to receive the animal right anterior and left anterior legs therethrough.

36. A garment in accordance with aspect 23, wherein the at least one posterior extension comprises a first subsection comprising the urogenital cover and the portion defining the aperture adapted to receive the animal tail therethrough, and a plurality of additional subsections, each additional subsection extending from the portion defining the aperture to the dorsolateral cover, and wherein each additional subsection comprises at least one attachment portion.

37. A garment in accordance with aspect 23, wherein the at least one posterior extension comprises a first subsection comprising the urogenital cover and the portion defining the aperture, a left subsection extending from the portion defining the aperture to the left lateral cover, and a right subsection extending from the portion defining the aperture to the right lateral cover, and wherein the left subsection and the right subsection each comprises at least one attachment portion.

38. A garment in accordance with aspect 1, comprising:
a cover adapted for covering the animal dorsal, left lateral, right lateral, ventral and urogenital regions, the cover comprising a dorsal cover portion, a left lateral cover portion comprising the at least one first attachment portion, and a right lateral cover portion comprising the at least one second attachment portion;
a left anterior extension comprising at least one left anterior attachment portion;
a right anterior extension comprising at least one right anterior attachment portion; and
a posterior extension defining an aperture for receiving the animal tail, and further comprising 1) a urogenital cover portion adapted to cover the animal urogenital, left ventrolateral and right ventrolateral regions, 2) at least one left ventrolateral attachment portion, and 3) at least one right ventrolateral attachment portion,
   wherein the left anterior extension and the right anterior extension each extends obliquely from the dorsolateral cover.

39. A garment in accordance with aspect 38, wherein the at least one left anterior attachment portion and the at least one right anterior attachment portion comprise at least one attachment adapted for attaching the anterior extensions to each other at the neck region of the animal.

40. A garment in accordance with aspect 39, comprising at least one attachment comprising the at least one left ventrolateral attachment portion of the posterior extension and the at least one first attachment portion, and at least one attachment comprising the at least one right ventrolateral attachment portion of the posterior extension and the at least one second attachment portion.

41. A garment in accordance with aspect 40, Wherein each attachment is a reversible attachment.

42. A garment in accordance with aspect 41, wherein each reversible attachment is independently selected from the group consisting of at least one velcro attachment, at least one button/buttonhole; at least one hook/eye, at least one snap, at least one zipper, and a combination thereof.

43. A garment in accordance with aspect 41, wherein each reversible attachment is a velcro attachment.

44. A garment in accordance with aspect 1, comprising:
a ventral cover adapted for covering the animal's abdomen and chest regions;
a left dorsolateral cover comprising the at least one first attachment portion;
a right dorsolateral cover comprising the at least one second attachment portion;
a left anterior extension comprising at least one left anterior attachment portion;
a right anterior extension comprising at least one right anterior attachment portion; and
a posterior extension defining an aperture for receiving the animal tail, and comprising 1) a urogenital cover portion adapted to cover the animal urogenital region, 2) a dorsoposterior portion adapted to cover the animal dorsal posterior region, said dorsoposterior portion comprising at least one left attachment portion and at least one right attachment portion,
   wherein each anterior extension extends obliquely from the abdominal cover.

45. A garment in accordance with aspect 44, comprising:
a) at least one left dorsal attachment comprising the at least one first attachment portion and the at least one left attachment portion of the posterior extension;
b) at least one right dorsal attachment comprising the at least one second attachment portion and the at least one right attachment portion of the posterior extension; and
c) at least one anterior attachment comprising the at least one left anterior attachment portion and the at least one right anterior attachment portion.

46. A garment in accordance with aspect 45, wherein each attachment is a reversible attachment.

47. A garment in accordance with aspect 46, wherein each reversible attachment is independently selected from the group consisting of at least one velcro attachment, at least one button/buttonhole; at least one hook/eye, at least one snap, at least one zipper, and a combination thereof.

48. A garment in accordance with aspect 46, wherein each reversible attachment is a velcro attachment.

49. A garment in accordance with aspect 1, comprising:
a ventral cover adapted for covering the animal's abdomen and chest regions;
a left dorsolateral cover comprising the at least one first attachment portion;
a right dorsolateral cover comprising the at least one second attachment portion;
a left anterior extension comprising at least one left anterior attachment portion;
a right anterior extension comprising at least one right anterior attachment portion,
   wherein each anterior extension extends obliquely from the abdominal cover; and
a posterior extension comprising 1) a urogenital cover portion, 2) a dorsoposterior portion comprising at least one left dorsoposterior attachment portion and at least one right dorsoposterior attachment portion.

50. A garment in accordance with aspect 49, wherein the posterior extension comprises a first subsection comprising the urogenital cover and the portion defining the aperture adapted to receive the animal tail therethrough, and a plurality of additional subsections, each additional subsection extending from the portion defining the aperture to the dorsolateral cover, and wherein each additional subsection comprises at least one attachment portion.

51. A garment in accordance with aspect 49, wherein the posterior extension comprises a first subsection comprising the urogenital cover and the portion defining the aperture, a left subsection extending from the portion defining the aperture to the left lateral cover, and a right subsection extending from the portion defining the aperture to the right lateral cover, and wherein the left subsection and the right subsection each comprises at least one attachment portion.

52. A garment in accordance with aspect 49, comprising:
a) at least one left dorsal attachment comprising the at least one first attachment portion and the at least one left attachment portion of the posterior extension;
b) at least one right dorsal attachment comprising the at least one second attachment portion and the at least one right attachment portion of the posterior extension; and
c) at least one anterior attachment comprising the at least one left anterior attachment portion and the at least one right anterior attachment portion.

53. A garment in accordance with aspect 52, wherein each attachment is a reversible attachment.

54. A garment in accordance with aspect 53, wherein each reversible attachment is independently selected from the group consisting of at least one velcro attachment, at least one button/buttonhole; at least one hook/eye, at least one snap, at least one zipper, and a combination thereof.

55. A garment in accordance with aspect 53, wherein each reversible attachment is a velcro attachment.

56. A garment in accordance with aspect 1, comprising:
a ventral cover;
a left dorsolateral cover comprising the at least one first attachment portion, wherein the at least one first attachment portion is adapted to the animal dorsal midline;
a right dorsolateral cover comprising the at least one second attachment portion, wherein the at least one second attachment portion is adapted to the animal dorsal midline;
an anterior left extension;
an anterior right extension; and
a posterior extension defining an aperture for receiving the animal tail, and comprising 1) a urogenital cover portion adapted to cover the animal urogenital region, 2) a dorsoposterior portion adapted to cover the animal dorsal posterior region, said dorsoposterior portion comprising at least one first dorsoposterior attachment portion.

57. A garment in accordance with aspect 56, wherein the anterior left extension and the anterior right extension are attached, whereby the garment defines an aperture for receiving the animal front legs therethrough.

58. A garment in accordance with aspect 56, wherein at least one of the at least one first attachment portion and the at least one second attachment portion further comprises at least one first dorsoposterior attachment portion.

59. A garment in accordance with aspect 56, comprising at least one first attachment comprising a) the at least one first attachment portion, and b) at least one second attachment portion.

60. A garment in accordance with aspect 59, further comprising at least one second attachment comprising c) the at least one first dorsoposterior attachment portion and d) the at least one second dorsoposterior attachment portion.

61. A garment in accordance with aspect 60, wherein each attachment is a reversible attachment.

62. A garment in accordance with aspect 61, wherein each reversible attachment is independently selected from the group consisting of at least one velcro attachment, at least one button/buttonhole; at least one hook/eye, at least one snap, at least one zipper, and a combination thereof.

63. A garment in accordance with aspect 61, wherein each reversible attachment is a velcro attachment.

64. A garment in accordance with aspect 1, comprising:
a ventral cover;
a left dorsolateral cover comprising the at least one first attachment portion and at least one left secondary attachment portion;
a right dorsolateral cover comprising the at least one second attachment portion and at least one right secondary attachment portion;
an anterior left extension;
an anterior right extension; and
a posterior extension comprising 1) a urogenital cover portion, 2) a dorsoposterior portion comprising at least one la dorsoposterior attachment portion and at least one right dorsoposterior attachment portion.

65. A garment in accordance with aspect 64, wherein the anterior left extension and the anterior right extension are attached, whereby the garment defines an aperture for receiving the animal front legs therethrough.

66. A garment in accordance with aspect 64, comprising at least one primary attachment adapted to the animal dorsal midline, comprising the at least one first attachment portion and the at least one second attachment portion.

67. A garment in accordance with aspect 66, comprising at least one left secondary attachment comprising the at least one left secondary attachment portion and the at least one left dorsoposterior attachment portion.

68. A garment in accordance with aspect 67, comprising at least one right secondary attachment comprising the at least one right secondary attachment portion and the at least one right dorsoposterior attachment portion.

69. A garment in accordance with aspect 68, wherein each attachment is a reversible attachment.

70. A garment in accordance with aspect 69, wherein each reversible attachment is independently selected from the group consisting of at least one velcro attachment, at least one button/buttonhole; at least one hook/eye, at least one snap, at least one zipper, and a combination thereof.

71. A garment in accordance with aspect 69, wherein each reversible attachment is a velcro attachment.

72. A garment for covering the penis of a male quadruped mammal, comprising a primary portion adapted to a) encircle at least a portion of a male mammal's trunk and b) cover the male mammal's penis, wherein the primary portion comprises a first flap and a second flap, and wherein the first flap comprises at least one first attachment portion and the second flap comprises at least one second attachment portion.

73. A garment in accordance with aspect 72, wherein the male quadruped mammal is selected from the group consisting of a canine mammal, a feline mammal, an ovine mammal, a bovine mammal, a porcine mammal, a caprine mammal, an equine mammal, and a leporine mammal.

74. A garment in accordance with aspect 72, wherein the mammal is a male canine mammal.

75. A garment in accordance with aspect 72, comprising an elastomeric material.

76. A garment in accordance with aspect 75, wherein the elastomeric material has a low coefficient of friction.

77. A garment in accordance with aspect 75, wherein the elastomeric material is spandex.

78. A garment in accordance with aspect 75, further comprising trim along at least one edge of said garment.

79. A garment in accordance with aspect 78, wherein said trim comprises an elastomeric material.

80. A garment in accordance with aspect 79, wherein the elastomeric material has a low coefficient of friction.

81. A garment in accordance with aspect 80, wherein the elastomeric material is spandex.

82. A garment in accordance with aspect 78, wherein said trim is attached to an edge by a stretchable attachment.

83. A garment in accordance with aspect 82, wherein the stretchable attachment comprises expandable stitching.

84. A garment in accordance with aspect 78, wherein said trim is attached to an edge by transversely alternating stitching.

85. A garment in accordance with aspect 72, further comprising at least one absorbent pad adjacent to the portion adapted to cover the penis.

86. A garment in accordance with aspect 85, wherein the at least one absorbent pad is adhered to the portion adapted to cover the penis.

87. A garment in accordance with aspect 85, wherein the at least one absorbent pad is reversibly adhered to the portion adapted to cover the penis.

88. A garment in accordance with aspect 85, wherein the at least one absorbent pad is adapted to be positioned adjacent to the animal's penis.

89. A garment in accordance with aspect 72, wherein the first flap is shorter than the second flap, the at least one first attachment portion is along a lateral edge of the first flap; and the at least one second attachment portion is along a lateral edge of the second flap.

90. A garment in accordance with aspect 89, further comprising:
a first extension extending from the primary portion, the first extension comprising at least one third attachment portion; and
a second extension extending from the primary portion, the second extension comprising at least one fourth attachment portion,
   wherein the first extension and the second extension are of unequal lengths.

91. A garment in accordance with aspect 90, comprising:
at least one first attachment comprising the at least one first attachment portion and the at least one second attachment portion; and
a second attachment comprising the at least one third attachment portion and the at least one fourth attachment portion, whereby the first extension and the second extension define a first aperture adapted to receive the male mammal's head and neck, and whereby the garment defines an aperture adapted to receive the male mammal's forelegs, and wherein the first attachment is adapted to be worn along a lateral portion of the animal trunk.

92. A garment in accordance with aspect 91, wherein each attachment is a reversible attachment.

93. A garment in accordance with aspect 92, wherein each reversible attachment is independently selected from the group consisting of at least one velcro attachment, at least one button/buttonhole; at least one hook/eye, at least one snap, at least one zipper, and a combination thereof.

94. A garment in accordance with aspect 92, wherein each reversible attachment is a velcro attachment.

95. A garment in accordance with aspect 72, further comprising:
a chest cover extending from the primary portion;
a first extension extending obliquely from the chest cover, the first extension comprising at least one third attachment portion; and
a second extension extending obliquely from the chest cover, the second extension comprising at least one fourth attachment portion,
   wherein the first extension and the second extension are of equal lengths.

96. A garment in accordance with aspect 95, comprising:
at least one first attachment comprising the at least one first attachment portion and the at least one second attachment portion; and
a second attachment comprising the at least one third attachment portion and the at least one fourth attachment portion, wherein the first attachment is adapted to be worn along the animal dorsum, and whereby the first extension and the second extension define a first aperture adapted to receive the male mammal's head and neck, and whereby the garment defines an aperture adapted to receive the male mammal's forelegs.

97. A garment in accordance with aspect 96, wherein each attachment is a reversible attachment.

98. A garment in accordance with aspect 97, wherein each reversible attachment is independently selected from the group consisting of at least one velcro attachment, at least one button/buttonhole; at least one hook/eye, at least one snap, at least one zipper, and a combination thereof.

99. A garment in accordance with aspect 98, wherein each reversible attachment is a velcro attachment.

100. A garment in accordance with aspect 72, wherein the primary portion comprises two symmetrically disposed flaps, wherein a first flap comprises the first attachment portion and a second flap comprises the second attachment portion, the garment further comprising an extension extending from the primary portion, said extension adapted to extend anteriorly over the animal ventral region, said extension further comprising at least one third attachment portion and at least one fourth attachment portion.

101. A garment in accordance with aspect 100, comprising:
a) at least one dorsal attachment comprising the at least one first attachment portion and the at least one second attachment portion, and b) at least one anterior attachment comprising the at least one third attachment portion and the at least one fourth attachment portion, whereby the at least one anterior attachment and the extension form a loop adapted to secure the extension to an animal neck collar.

102. A garment in accordance with aspect 101, wherein each attachment is a reversible attachment.

103. A garment in accordance with aspect 102, wherein each reversible attachment is independently selected from the group consisting of at least one velcro attachment, at least one button/buttonhole; at least one hook/eye, at least one snap, at least one zipper, and a combination thereof.

104. A garment in accordance with aspect 102, wherein each reversible attachment is a velcro attachment.

105. A garment in accordance with aspect 1, comprising:
a ventral cover;
a left dorsolateral cover comprising the at least one first attachment portion;
a right dorsolateral cover comprising the at least one second attachment portion;
   wherein the left dorsolateral cover is adjoined to the right dorsolateral cover;
an anterior left extension;
an anterior right extension; and
a posterior extension comprising 1) a urogenital cover portion, 2) a portion defining an aperture adapted to receive the animal tail therethrough, and 3) a dorsoposterior portion comprising at least one left dorsoposterior attachment portion and at least one right dorsoposterior attachment portion,
   whereby the garment is adapted to encircle the animal's trunk.

106. A garment in accordance with aspect 105, wherein the anterior left extension and the anterior right extension are adjoined, whereby the garment defines an aperture for receiving the animal front legs therethrough and an aperture for receiving the animal head therethrough.

107. A garment in accordance with aspect 105, further comprising:
at least one first attachment comprising a) the at least one first attachment portion, and b) the at least one left dorsoposterior attachment portion: and
at least one second attachment comprising a) the at least one second attachment portion, and b) the at least one right dorsoposterior attachment portion

108. A garment in accordance with aspect 107, wherein each attachment is a reversible attachment.

109. A garment in accordance with aspect 108, wherein each reversible attachment is independently selected from the group consisting of at least one velcro attachment, at least one button/buttonhole; at least one hook/eye, at least one snap, at least one zipper, and a combination thereof.

110. A garment in accordance with aspect 108, wherein each reversible attachment is a velcro attachment.

All publications cited herein are incorporated by reference, each in its entirety.

What is claimed is:

1. A garment adapted for covering the urogenital region of a quadruped animal, comprising:
at least one urogenital cover;
at least one first attachment portion; and
at least one second attachment portion, wherein the garment comprises an elastomeric material.

2-5. (canceled)

6. A garment in accordance with claim 1, wherein the animal is a canine mammal.

7. (canceled)

8. A garment in accordance with claim 1, wherein the elastomeric material has a low coefficient of friction.

9. A garment in accordance with claim 8, wherein the elastomeric material is spandex.

10. A garment in accordance with claim 1, further comprising trim comprising an elastomeric material along at least one edge of said garment.

11-13. (canceled)

14. A garment in accordance with claim 10, wherein the trim is attached along the at least one edge by expandable stitching.

15-16. (canceled)

17. A garment in accordance with claim 1, further comprising at least one absorbent pad adjacent to and adhered to the urogenital cover.

18-20. (canceled)

21. A garment adapted for covering the urogenital region of a quadruped animal, comprising:
at least one urogenital cover;
at least one first attachment portion;
at least one second attachment portion;
a dorsolateral cover portion comprising a dorsal cover adapted for covering the animal's dorsal region, a left lateral cover adapted for covering the animal's left lateral region and a right lateral cover adapted for covering the animal's right lateral region; and
a ventral cover portion extending between the left lateral cover and the right lateral cover and further comprising a urogenital cover adapted for covering the animal's urogenital region.

22. A garment in accordance with claim 21, further comprising at least one posterior extension extending from the urogenital cover portion, wherein the at least one posterior extension further comprises a portion defining an aperture adapted to receive the animal tail therethrough.

23. (canceled)

24. A garment in accordance with claim 22, wherein the at least one posterior extension further comprises a portion extending between the portion defining an aperture adapted to receive the animal tail therethrough and the dorsolateral cover portion.

25-26. (canceled)

27. A garment in accordance with claim 21, comprising at least one velcro attachment comprising the at least one first attachment portion and the at least one second attachment portion.

28-30. (canceled)

31. A garment in accordance with claim 27, wherein the at least one attachment attaches the posterior extension to the dorsal cover.

32. A garment in accordance with claim 21, further comprising a chest cover adapted for covering the animal chest region.

33. A garment in accordance with claim 21, wherein the garment further defines a head aperture adapted to receive the animal head therethrough.

34. A garment in accordance with claim 21, wherein the garment further defines a first aperture adapted to receive the animal left anterior leg therethrough and a second aperture adapted to receive the animal right anterior leg therethrough.

35. A garment in accordance with claim 21, wherein the garment further defines an aperture adapted to receive the animal right anterior and left anterior legs therethrough.

36-37. (canceled)

38. A garment in accordance with claim 1, comprising:
a cover adapted for covering the animal dorsal, left lateral, right lateral, ventral and urogenital regions, the cover comprising a dorsal cover portion, a left lateral cover portion comprising the at least one first attachment portion, and a right lateral cover portion comprising the at least one second attachment portion;
a left anterior extension comprising at least one left anterior attachment portion;
a right anterior extension comprising at least one right anterior attachment portion; and
a posterior extension defining an aperture for receiving the animal tail, and further comprising 1) a urogenital cover portion adapted to cover the animal urogenital, left ventrolateral and right ventrolateral regions, 2) at least one left ventrolateral attachment portion, and 3) at least one right ventrolateral attachment portion,
wherein the left anterior extension and the right anterior extension each extends obliquely from the dorsolateral cover.

39-71. (canceled)

72. A garment for covering the penis of a male quadruped mammal, comprising a primary portion adapted to a) encircle at least a portion of a male mammal's trunk and b) cover the male mammal's penis, wherein the primary portion comprises a first flap and a second flap, and wherein the first flap comprises at least one first attachment portion and the second flap comprises at least one second attachment portion.

73-74. (canceled)

75. A garment in accordance with claim 72, comprising an elastomeric material having a low coefficient of friction.

76-88. (canceled)

89. A garment in accordance with claim 72, wherein the first flap is shorter than the second flap, the at least one first attachment portion is along a lateral edge of the first flap; and the at least one second attachment portion is along a lateral edge of the second flap.

90-94. (canceled)

95. A garment in accordance with claim 72, further comprising:
a chest cover extending from the primary portion;
a first extension extending obliquely from the chest cover, the first extension comprising at least one third attachment portion; and
a second extension extending obliquely from the chest cover, the second extension comprising at least one fourth attachment portion,
wherein the first extension and the second extension are of equal lengths.

96-99. (canceled)

100. A garment in accordance with claim 72, wherein the primary portion comprises two symmetrically disposed flaps, the first flap comprises the first attachment portion and the second flap comprises the second attachment portion, and wherein the garment further comprises an extension extending from the primary portion, said extension adapted to extend anteriorly over the animal ventral region, said extension further comprising at least one third attachment portion and at least one fourth attachment portion.

101. A garment in accordance with claim 100, comprising:
a) at least one dorsal attachment comprising the at least one first attachment portion and the at least one second attachment portion, and b) at least one anterior attachment comprising the at least one third attachment portion and the at least one fourth attachment portion, whereby the at least one anterior attachment and the extension form a loop adapted to secure the extension to an animal neck collar.

102. (canceled)

103-104. (canceled)

105. A garment in accordance with claim 1, comprising:
a ventral cover;
a left dorsolateral cover comprising the at least one first attachment portion;
a right dorsolateral cover comprising the at least one second attachment portion;
wherein the left dorsolateral cover is adjoined to the right dorsolateral cover;
an anterior left extension;
an anterior right extension; and
a posterior extension comprising 1) a urogenital cover portion, 2) a portion defining an aperture adapted to receive the animal tail therethrough, and 3) a dorsoposterior portion comprising at least one left dorsoposterior attachment portion and at least one right dorsoposterior attachment portion,
whereby the garment is adapted to encircle the animal's trunk.

106-110. (canceled)
